(19) United States
(12) Patent Application Publication
(10) Pub. No.: US 2026/0120043 A1
(43) Pub. Date: Apr. 30, 2026

(54) ELECTRONIC CREATION OF SHIPMENT RECORDS WITH ENHANCED SHIPMENT SECURITY AND TRACKING USING AUTOMATED IMAGE CAPTURE AND PROCESSING AND SECURITY DEVICE SCANNING FOR IMPROVED RELIABILITY OF SHIPMENT DATA AND SECURITY FEATURES

(71) Applicant: OVERHAUL GROUP, INC., Austin, TX (US)

(72) Inventors: BARRY CONLON, LEANDER, TX (US); JONATHAN RYAN, KILKENNY (IE)

(21) Appl. No.: 19/375,056

(22) Filed: Oct. 30, 2025

Related U.S. Application Data
(60) Provisional application No. 63/714,021, filed on Oct. 30, 2024.

(51) Int. Cl. G06Q 10/0833; G06F 40/174; G06Q 10/083; G06V 40/16

(52) U.S. Cl. CPC G06Q 10/0833; G06F 40/174; G06Q 10/0841; G06V 40/172

(57) ABSTRACT

An electronic device and method provide automated creation of shipments using image-capture-based information gathering and electronic scanning for ingesting data analyzed by a processor and an AI engine to generate relevant shipment detail that provides enhanced security with the shipment lifecycle, including during shipment creation, pickup from an origination point, route selection, and subsequent transportation of the shipment to its intended destination. One aspect includes presenting an image capture user interface that prompts image-based entry of one or more shipment details and security details. In response to detecting capture of an image or video of a shipping entity, the device/AI: assigns the captured image content to the shipment; processes the captured image content to determine relevant data for inclusion in/with the shipment; and generates a shipment record to include a combination of user entered data, the captured image content, and relevant data determined from the captured image content.

### PRIORITY & RELATED APPLICATIONS

The present application claims priority from U.S. Provisional Application No. 63/714,021, filed on Oct. 30, 2024, with the entire content of that provisional application being incorporated herein.

### BACKGROUND OF THE INVENTION

### 1. Field of the Invention

The present disclosure is generally related to portable electronic devices that are used in the shipping of goods, and in particular to portable computing devices use in the shipping of goods and method for using the same for shipment data creation and tracking.

### 2. Description of the Related Art

The cargo shipping industry is becoming more technology savy and continues to incorporate more advanced technology to support the transportation and security of shipments in order to efficiently and securely move goods or cargo from an origination point to a destination point. Often, each new shipment has specific sets of shipping details and shipping parameters that are unique to that shipment and which have to be specified to one or more of the entities (i.e., shippers, brokers, operators, drivers, etc.) that participate in some aspect of the shipment, at different points of the shipment cycle.

Traditionally, creating a new shipment requires the generation of a printed or written document (e.g., an airway bill) with the shipment details that are provided being manually typed or written in text on paper. Modern shipping processes provide access to electronic documents, as fillable online forms, that require a shipper, driver, or other user of an electronic device to input the shipment related information by manually typing that information in. As security considerations are added to these shipments, the amount of data that has to be entered manually increases significantly and the creation of these shipment documents become rather tedious and time-consuming, with many opportunities for errors introduced by the manual processing.

### SUMMARY

Disclosed are an electronic device and a method for autonomously generating a shipment record for a new shipment utilizing image-based entry of shipment related information, including images of a driver, the shipping vessel(s) (e.g., tractor-trailer combination), and digitized scanning of security features associated with the shipment. According to one aspect, an artificial intelligence (AI) agent is deployed on a user device, such as a tablet, and provided with access to AI data models to support the processing and use of the image-based entries and scanned security data.

One or more embodiments of the disclosure provide an electronic device comprising: a communication subsystem configured to support communication between the electronic device and at least one shipment monitoring and security tracking (SMST) server/system via a communications network. The electronic device includes: at least one input device; at least one output device, including a display that presents one or more user interfaces and prompts rendered by the electronic device; at least one camera that captures images and video within a field of view (FOV) of an integrated camera lens; and a memory having an automated shipment creation (ASC) module comprising a shipment generation application with automated image capture and processing and automated scanning and association of security features. The electronic device includes a controller having at least one processor communicatively coupled to the communication subsystem, each of the at least one input device, each of the at least one output device, and the memory. The at least one processor executes program instructions of the ASC module. The processor is configured to cause the electronic device to, in response to receiving a first input for activation of the shipment generation application for creating or completing a first shipment record, present a login user interface (UI) on the display of the electronic device, the login UI comprising one or more prompts and entry fields for receiving user login via input of credentials and/or biometrics. The processor is further configure to cause the electronic device to, in response to confirming receipt of an authenticated login: render and present on the display at least one data collection UI for receiving shipment details and/or shipment security details corresponding to an upcoming shipment being established for tracking via the SMST system; and present a first data collection UI among the at least one data collection UI with a listing of shipment-related entities requiring image capture and corresponding image capture affordances for initiating image-based input of one or more of the shipment details and/or shipment security details. The processor is further configured to cause the electronic device to, in response to selection of an image capture affordance: automatically activate a first camera among the at least one camera; and present on the display instructions indicating what information is desired to be captured by the first camera for the first set of data. The processor is further configured to cause the electronic device to, in response to detecting capture of an image or video with corresponding image content: store the captured image content to local storage; assign the captured image content to the shipment as a corresponding one of a shipment related image and/or a shipment security related image; and process the captured image content to determine relevant data for inclusion in the first shipment record. The processor is further configured to cause the electronic device to generate the first shipment record to include a combination of user entered data, the captured image content, and relevant data determined from the captured image content. The processor is further configured to cause the electronic device to transmit the first shipment record comprising the captured image content along with other received shipment data and security data to the SMTS server to trigger SMTS server to activate image-based security monitoring and tracking of the created shipment.

Additionally, as one additional aspect of the disclosure, the at least one processor is configured to cause the electronic device to, present a first data collection UI among the at least one data collection UI with a listing of shipment-related entities requiring image capture and corresponding image capture affordances for initiating image-based input of one or more of the shipment details and/or shipment security details. The processor is further configured to cause the electronic device to, in response to selection of the selectable scan affordance/option within a corresponding security data collection UI among the at least one data collection UI: automatically activate a corresponding scanner among one or more available scanners; and present on the display instructions indicating what information is desired to be scanned by the activated scanner. The processor is further configured to cause the electronic device to, in response to detecting capture of scanned digitized data or a connection code during an activated scan operation of the electronic device: store the captured scanned digitized data to local storage; assign the scanned digitized data to the shipment as a corresponding one of associated security related data for tracking security of the shipment; and process the scanned digitized data to identify an associated device. The processor is further configured to cause the electronic device to: communicatively connect with the associated device when the device is configured to support wireless network connectivity; download device characteristics for the connected device; and modify an UI of the application to present a listing of the connected device along an identifier and status information corresponding to the connected device. The processor is further configured to cause the electronic device to integrate relevant data of the connected device into the first shipment record; and generate the first shipment record to include a combination of user entered data, the captured image content, relevant data determined from the captured image content, and status and tracking information for the scanned security devices. The processor is further configured to cause the electronic device to transmit the first shipment record comprising the captured image content and the scanned content, along with other received shipment data and security data to the SMTS server to trigger SMTS server to activate image-based security monitoring and tracking of the created shipment.

According to one or more aspects, the ASC module includes AI and/or AI models, and at least one processor is configured to cause the electronic device to activate an artificial intelligence (AI) agent/engine on the electronic device, where the AI agent processes data received during intake of the shipment details and the shipment security details to autonomously generate a shipment record with integrated security features comprising one or more images of at least one of a driver, a tactor, a trailer, a cargo, a door seal, a security tag, and a barcode.

In one or more embodiments, the AI agent, in response to receiving an image or video contemporaneously with the electronic device outputting a request or prompt for image capture of a driver/operator of a shipment transport vessel: evaluates one or more frames of the image or video for a face; in response to detecting a face, compares one or more characteristics of the detected face against a local image database comprising facial images of one or more driver/operator, each having an associated driver identifier (ID) and corresponding driver related data; and identify the driver and the associated driver ID, in response to a match of the detected face within the local image database. Additionally, the at least one processor is further configured to cause the electronic device to, in response to finding a match of the detected face with a first facial image stored within the local image database: determine from evaluating information about the specific shipment and the corresponding driver related data, whether the driver identified in the captured image is a correct driver to receive the shipment; and in response to the identified driver not being deemed the correct driver, activate a shipment hold to prevent generation of final shipping documents required to enable dispatch of the shipment.

In one or more embodiments, the at least one processor is further configured to cause the electronic device to: in response to the identified driver being confirmed as the correct driver, match the identified driver to the specific shipment within the first shipment record; and update the first shipment record to include shipping data and the facial image of the identified driver for use as a security confirmation image during shipment delivery verification.

In one or more embodiments, in response to identifying the driver in the local image database, the at least one processor is further configured to cause the electronic device to: access, via the communication subsystem, using the associated ID, a shipping database of driver/operators having associated driver IDs and specific characteristics (e.g., shipping clearances and shipment authorizations of the driver, and driver ratings) and corresponding to the identified driver/operator for a plurality of authorized and/or approved drivers; and download and autonomously enter relevant driver and shipping data for the identified driver/operator to the first shipment record, in part based on the specific characteristics of the identified driver/operator.

In one or more embodiments, the AI agent, in response to not identifying a match of the detected face within the local image database: triggers the electronic device to access, via the communication subsystem, a remote image database and trigger a comparison of the detected face against a plurality of driver images in the remote image database; and in response to a match to a driver image in the remote image database, retrieve, from the remote image database, a corresponding identifier (ID) of the driver and other data associated with the driver. Also, the at least one processor is further configured to cause the electronic device to, in response to finding a match of the detected face within the remote image database: determine from evaluating information about the specific shipment and the corresponding driver related data, whether the driver identified in the captured image is a correct driver to receive the shipment; and in response to the identified driver not being deemed the correct driver, activate a shipment hold to prevent generation of final shipping documents required to enable dispatch of the shipment. The at least one processor is further configured to cause the electronic device to, in response to the identified driver being confirmed as the correct driver: match the identified driver to the specific shipment within the first shipment record; and update the first shipment record to include shipping data and the facial image of the identified driver for use as a security confirmation image during shipment delivery verification.

In one or more embodiments, in response to the identified driver not being deemed the correct driver, the at least one processor is further configured to cause the electronic device to: generate and transmit, to the SMTS server, a notification that triggers the SMTS server to generate and transmit a second notification to a second communication device of at least one interested shipment related entity registered to receive notifications about potential security issues occurring with the first shipment.

In one or more embodiments, the at least one processor is further configured to cause the electronic device to: in response to a match of the detected face, update and/or supplement an entry of the first facial image in the local image database with the detected face.

In one or more embodiments, the AI agent, in response to receiving an image or video of a document contemporaneously with outputting a request for entry of shipment related data within a data entry UI comprising at least one data input field: analyzes the UI to identify a type of data required to be entered into each data field of the data entry UI; evaluates and extracts relevant content from the received document image that aligns with the type of data required for each data field of the data entry UI; and autonomously adds the relevant content extracted from the received image or video of the document to granularly complete entry of the relevant content within a corresponding data field.

In one or more embodiments, the at least one processor is configured to cause the electronic device to: receive, as the user login, credentials and/or biometrics comprising at least one of: a text input of a login passcode received via an input device at a user interface presented on the display of the device; a biometric input from among: (i) voice audio input presented as a biometric security input that provides access to the electronic device and activates shipment creation functions of the electronic device for a driver identified as having the voice print of the receive voice audio input; (ii) a fingerprint input that opens the shipment generation UI on the display of the device with information associated with the driver pre-filled for that driver whose fingerprint was authenticated; other biometric input, such as an iris or facial scan. Further, in response to receiving the user login credentials and/or biometrics, the at least one processor is configured to cause the electronic device to: authenticate the user login as a valid/approved login; retrieve and present on the display a series of user interfaces for receipt of the shipment data and the security data for the shipment being created; identify an identity and a role of the user whose login credentials and/or biometrics was utilized to access the shipment creation UI; and auto-populate information related to the shipment based on the identity and role of the user whose login credentials was utilized to gain access to the shipment creation UI.

In one or more embodiments, the electronic device includes a location sensor coupled to the at least one processor. The at least one processor is configured to cause the electronic device to: identify, from location data received from the location sensor, a current geographic location of the electronic device; access a database of approved shipment originating addresses or shipping entity facility locations having a known shipping location from which an authenticated one of a driver, an operator, a shipper, a recipient can initiate document preparation for a local shipment pickup; and responsive to the current geographic location being an approved shipment originating address or shipping entity facility location, autonomously associate and enter into a shipment origination address field of the first shipment record, an address of the current geographic location as a shipment origination address, and a name and contact details of the authenticated user in a shipment creator field.

In one or more embodiments, the at least one processor is configured to cause the electronic device to: render and present, on the display, a shipment creation/security user interface (UI) that presents selectable options and prompts for capturing of electronic images of one or more shipment record data and shipment security data from a group comprising the driver, the driver's physical identification (ID) or license, the tractor, the trailer, the tractor VIN number, the cargo/shipment's exterior packaging, the cargo, a shipping label or identifier attached to the shipment packaging, a bar code, a cargo seal, a door seal, and the shipping facility/environment.

In one or more embodiments, the electronic device includes an electronic tag reader communicatively coupled to the at least one processor. The at least one processor is configured to cause the electronic device to: render and present, within a shipment creation UI, a tag capturing request or prompt to trigger scanning of an electronic tag having a unique signature and attached to one or more of the shipment packaging, the trailer, the cargo, a pallet on which the cargo is placed, a container in which the cargo is placed, or other scannable location in proximity to the cargo during the shipment; and responsive to receipt of scan data from scanning the tag, embed the scan data into the first shipment record and upload the scan data to the SMTS system with the first shipment record.

In one or more embodiments, the electronic device includes an electronic barcode reader communicatively coupled to the at least one processor. The at least one processor is configured to cause the electronic device to: render and present, within a shipment creating UI, a barcode scanning request or prompt for initiation of a scan of a barcode affixed to an exterior of a shipment and/or on documents corresponding to the shipment, the barcode comprising electronic data in printed form that identifies relevant information corresponding to the shipment, the barcode usable to identify and link the shipment to the electronic shipment record being generated; add, via an AI engine, the scanned barcode to an electronically generated record for the shipment, the electronically generated record being printable with the scanned barcode affixed thereto; and add, via the AI engine, the scanned barcode to a printable label generated for attaching to an exterior packaging of the shipment.

In one or more embodiments, the at least one processor is configured to cause the electronic device to: generate, as the first shipment record, a set of shipment related electronic documents that allows for security tagging and tracking of the created shipment, wherein the generation is completed by AI engine processing of the received images or video and scanned data, using one or more available AI data models. The AI engine utilizes an AI model that is pre-programmed to learn shipping patterns and habits associated with one or more of the shipper, the driver, insurance company, the shipment recipient, and/or other interested parties. Also, the AI engine further utilizes an AI model to determine additional shipping data, comprising a best route to a destination to be taken by a particular driver of a particular equipment for the particular shipment. The AI model learns shipping patterns and habits, and the AI engine identifies that different routes can be taken for a given shipment from a same origination point based on factors comprising one or more of: a type of shipment, a shipment origination point, a destination, a driver/operator, a shipper, an insurance coverage, a driver status and rating relative to other available drivers, a type of container, and/or a type of operator equipment or tractor-trailer.

In one or more embodiments, the at least one processor is configured to cause the electronic device to: store, within the first shipment record, collected shipment details including the generated shipment documents and one or more sets of captured images and/or image-retrieved information; and package and transmit the first shipment record to the (SMST) system to trigger server storage of the shipment details, wherein the shipment record is providing a record ID and made available for secure access by one or more authenticated shipment related entity during and after a life-cycle of the shipment.

The above presents a general summary of several aspects of the disclosure in order to provide a basic understanding of at least some aspects of the disclosure. The above summary contains simplifications, generalizations and omissions of detail and is not intended as a comprehensive description of the claimed subject matter but, rather, is intended to provide a brief overview of some of the functionality associated therewith. The summary is not intended to delineate the scope of the claims, and the summary merely presents some concepts of the disclosure in a general form as a prelude to the more detailed description that follows. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A illustrates an example portable electronic device, such as a tablet computer, configured with integrated hardware and software features to facilitate automated creation of an electronic shipment record by capturing and processing digital photographic images and/or videos of shipping entities and capturing electronic data of tags, seals, and barcodes to provide enhanced security integration during shipment record generation, in accordance with some embodiments;

FIG. 1B illustrates an example front surface of the portable electronic device of FIG. 1A having a front display on which is presented a login screen of a shipment creation user interface (UI) for initiating creation of a shipment record based on entry of user credentials or biometric authentication, in accordance with one or more embodiments;

FIG. 1C illustrates a back surface of the portable electronic device with two integrated cameras capable of being activated to capture images and video and/or to perform a scan function for scannable data to support automation of creation of the shipment record, in accordance with one or more embodiments;

FIG. 2 is a block diagram representation of an example artificial intelligence (AI) operating environment supporting a large action model and other AI models for implementing/supporting the implementation of several of the automated features described herein, according to a plurality of embodiments;

FIG. 3 is an example graphical user interface (GUI) presenting an example shipment connect user interface (UI) for a shipment creation application, from which many of the described features can be initiated, including creating a new shipment, capturing and integrating images into a shipment record, and scanning security devices to associate with the shipment, in accordance with one or more embodiments;

FIG. 4 depicts the display of the electronic device presenting an image capturing graphical user interfaces (GUI) of the shipment creation application that enable a user of the device to efficiently capture photographic images and videos of relevant entities involved in pickup and delivery of a particular shipment being created, to facilitate generation of the electronic shipment record with verifiable digitally-captured images and data, according to several embodiments;

FIGS. 5 and 6 illustrate the example use of the portable electronic device by a device user (driver/operator/shipper) to capture the requested images of the different entities involved in the shipment, including the driver, the tractor, trailer, and security components, including the security seal, according to several embodiments;

FIGS. 7A-7B illustrate presentation of captured images within the image capturing UI provided on the display, presenting the captured image of the tractor and the drive, respectively, to the device user, following corresponding image capture initiated from the GUI of FIG. 4, according to two embodiments;

FIG. 8 presents another example UI that provides a listing of the available security tags that have been scanned and associated with shipments for a same shipment entity or driver, according to some embodiments;

FIG. 9 presents another example UI that provides a listing of intelligent door seals that have been deployed and are being tracked by the user device, according to some embodiments;

FIG. 10 provides additional example GUIs presented for confirmation of driver-provided or AI-deduced information for associating with/within the shipment record, according to some embodiments;

FIG. 11 presents a list of driver directives automatically generated and provided to the driver of the shipment prior to release of the shipment to the driver, according to some embodiments;

FIGS. 12A-12B and 13 provide example UIs presenting selectable options for selecting/changing a route and breaking the selected route into segments, as a part of the enhanced shipment setup, according to some embodiments;

FIG. 14 illustrates an example UI presenting entry fields for supporting ocean and/or air segments of a shipment, according to some embodiments;

FIG. 15 presents an example pending pickup UI that electronically informs a driver of available shipments for pickup, with status information about the security devices assigned to the shipments, according to some embodiments;

FIG. 16 illustrates an example shipment generation, tracking, and communication environment within which a shipment record is generated using the example portable electronic device of FIGS. 1A-1C and within which delivery of a corresponding shipment is completed from an origination to a destination point, with tracking and security features enabled, according to one or more embodiments;

FIG. 17 illustrates an example data processing system (DPS) that operates as a shipment monitoring and security tracking (SMST) server/system to support shipment creation and storage of generated shipment records with digitally captured images and scanned security data that enable subsequent monitoring and security of the generated shipment, in accordance with one or more embodiments;

FIG. 18 provides a flow chart generally illustrating a method for shipment record creation that involves the capturing of digital images and electronic data that are then embedded within (or associated with) the shipment record by AI processing to improve and/or enhance the generation and subsequent security of the shipment, in accordance with one or more embodiments; and

FIG. 19A-19B (collectively FIG. 19) similarly provides a flow chart generally illustrating an alternate method for shipment record creation that involves the capturing of electronic images and scanned security-related data that are embedded within (or associated with) the shipment record by AI processing to enhance the generation and subsequent security of the shipment, in accordance with one or more embodiments; and

FIG. 20 provides a flow chart generally illustrating a method by which the capturing and processing of images of a driver are performed to support the automated image-assisted shipment creation with enhanced security of the shipment, in accordance with one or more embodiments.

### DETAILED DESCRIPTION OF ILLUSTRATIVE EMBODIMENTS

According to one or more aspects, the illustrative embodiments of the present disclosure provide a portable electronic device, a method, and a shipment tracking server that implement automated shipment record creation/generation with real-time image capturing of relevant shipping entities and scanning of security devices/components/features to facilitate electronic capturing of relevant shipment and security data that enables the shipment tracking server to support and provide enhanced shipment setup and security for all stages of the shipment.

In the shipment industry, creating a new shipment conventionally requires the generation of a printed or written document (e.g., an airway bill), with all of the shipment details being manually typed or written in text on paper. Modern shipping processes provide access to electronic documents, as fillable online forms, that require a shipper, driver, or other user with access to a computer to input the shipment related information by manually typing that information in. As security considerations are added to these shipments, including the use of barcodes, etc., the amount of data that has to be manually entered increases significantly and the creation of these shipment documents become rather tedious and time consuming, with many opportunities for errors introduced by the manual processing.

These physical paper and/or electronic forms typically include a unique tracking number that is assigned to the shipment. In some conventional applications, a shipping label with the unique tracking number can be printed out and provided to one or more interested parties. An electronic record of the shipping label or the particulars of the shipment can also be provided to the delivery person (e.g., the driver of the shipment transport vessel, such as a UPS truck) to allow that person to complete the transportation of the shipment to its intended destination. There is often no connection between the driver and the particular shipment other than the driver signing a document saying that he/she has picked up the shipment. This can oftentimes lead to the wrong driver picking up a shipment intended for another driver at a shipment dispatch location serviced by multiple drivers.

In the larger cargo shipping space, which typically employ tractor-trailers to carry larger cargo from an origination point to a destination and which have more specific shipment particulars/requirements and greater need to security, manually entering the various details for each shipment, requires a manual input of quite a lot of information by one or more persons to including both shipping details and security details. This process is again a very time consuming and tedious process. As previously stated, the manual entry of the information can often lead to errors due to inherent errors that are manifested when so much detail is being added/entered manually. A more efficient manner of generating a shipping control document that incorporates these additional parameters would therefore be a welcomed improvement to the industry. The present disclosure provides such a solution and also integrates added security into the shipment pickup process and provides localized security device management. Further, the solution provided cognitive learning of processes through the use of AI models and AI processing within the embodiments described herein.

According to one aspect of the disclosure, a portable and/or hand held user electronic device includes: a communication subsystem configured to support communication between the electronic device and at least one shipment monitoring and security tracking (SMST) server/system via a communications network. The electronic device includes: at least one input device; at least one output device, including a display that presents one or more user interfaces and prompts rendered by the electronic device; at least one camera that captures images and video within a field of view (FOV) of an integrated camera lens; and a memory having an automated shipment creation (ASC) module comprising a shipment generation application with automated image capture and processing and automated scanning and association of security features. The electronic device includes a controller having at least one processor communicatively coupled to the communication subsystem, each of the at least one input device, each of the at least one output device, and the memory. The at least one processor executes program instructions of the ASC module. The processor is configured to cause the electronic device to, in response to receiving a first input for activation of the shipment generation application for creating or completing a first shipment record, present a login user interface (UI) on the display of the electronic device, the login UI comprising one or more prompts and entry fields for receiving user login via input of credentials and/or biometrics. The processor is further configure to cause the electronic device to, in response to confirming receipt of an authenticated login: render and present on the display at least one data collection UI for receiving shipment details and/or shipment security details corresponding to an upcoming shipment being established for tracking via the SMST system; and present a first data collection UI among the at least one data collection UI with a listing of shipment-related entities requiring image capture and corresponding image capture affordances for initiating image-based input of one or more of the shipment details and/or shipment security details. The processor is further configured to cause the electronic device to, in response to selection of an image capture affordance: automatically activate a first camera among the at least one camera; and optionally present, on the display, instructions indicating what information is desired to be captured by the first camera for the first set of data. The processor is further configured to cause the electronic device to, in response to detecting capture of an image or video with corresponding image content: store the captured image content to local storage; assign the captured image content to the shipment as a corresponding one of a shipment related image and/or a shipment security related image; and process the captured image content to determine relevant data for inclusion in the first shipment record. The processor is further configured to cause the electronic device to generate the first shipment record to include a combination of user entered data, the captured image content, and relevant data determined from the captured image content. The processor is further configured to cause the electronic device to transmit the first shipment record comprising the captured image content along with other received shipment data and security data to the SMTS server to trigger SMTS server to activate image-based security monitoring and tracking of the created shipment.

Additionally, as one additional aspect of the disclosure, the at least one processor is configured to cause the electronic device to, present a first data collection UI among the at least one data collection UI with a listing of shipment-related entities requiring image capture and corresponding image capture affordances for initiating image-based input of one or more of the shipment details and/or shipment security details. The processor is further configured to cause the electronic device to, in response to detecting selection of the selectable scan affordance/option within a corresponding security data collection UI among the at least one data collection UI: automatically activate a corresponding scanner among one or more available scanners; and present on the display instructions indicating what information is desired to be scanned by the activated scanner. The processor is further configured to cause the electronic device to, in response to detecting capture of scanned digitized data or a connection code during an activated scan operation of the electronic device: store the captured scanned digitized data to local storage; assign the scanned digitized data to the shipment as a corresponding one of associated security related data for tracking security of the shipment; and process the scanned digitized data to identify an associated device. The processor is further configured to cause the electronic device to: communicatively connect with the associated device when the device is configured to support wireless network connectivity; download device characteristics for the connected device; and modify an UI of the application to present a listing of the connected device along an identifier and status information corresponding to the connected device. The processor is further configured to cause the electronic device to integrate relevant data of the connected device into the first shipment record; and generate the first shipment record to include a combination of user entered data, the captured image content, relevant data determined from the captured image content, and status and tracking information for the scanned security devices. The processor is further configured to cause the electronic device to transmit the first shipment record comprising the captured image content and the scanned content, along with other received shipment data and security data to the SMTS server to trigger SMTS server to activate image-based security monitoring and tracking of the created shipment.

According to one or more aspects, the ASC module includes AI and/or AI models, and at least one processor is configured to cause the electronic device to activate an artificial intelligence (AI) agent/engine on the electronic device, where the AI agent processes data received during intake of the shipment details and the shipment security details to autonomously generate a shipment record with integrated security features comprising images of one or more of a driver, a tactor, a trailer, a cargo, a door seal, a security tag, and a barcode.

In one or more embodiments, the AI agent, in response to receiving an image or video contemporaneously with the electronic device outputting a request or prompt for image capture of a driver/operator of a shipment transport vessel: evaluates one or more frames of the image or video for a face; in response to detecting a face, compares one or more characteristics of the detected face against a local image database comprising facial images of one or more driver/operator, each having an associated driver identifier (ID) and corresponding driver related data; and identify the driver and the associated driver ID, in response to a match of the detected face within the local image database. Additionally, the at least one processor is further configured to cause the electronic device to, in response to finding a match of the detected face with a first facial image stored within the local image database: determine from evaluating information about the specific shipment and the corresponding driver related data, whether the driver identified in the captured image is a correct driver to receive the shipment; and in response to the identified driver not being deemed the correct driver, activate a shipment hold to prevent generation of final shipping documents required to enable dispatch of the shipment.

In one or more embodiments, the at least one processor is further configured to cause the electronic device to: in response to the identified driver being confirmed as the correct driver, match the identified driver to the specific shipment within the first shipment record; and update the first shipment record to include shipping data and the facial image of the identified driver for use as a security confirmation image during shipment delivery verification.

In one or more embodiments, the at least one processor is configured to cause the electronic device to: generate, as the first shipment record, a set of shipment related electronic documents that allows for security tagging and tracking of the created shipment, wherein the generation is completed by AI engine processing of the received images or video and scanned data, using one or more available AI data models. The AI engine utilizes an AI model that is pre-programmed to learn shipping patterns and habits associated with one or more of the shipper, the driver, insurance company, the shipment recipient, and/or other interested parties. Also, the AI engine further utilizes an AI model to determine additional shipping data, comprising a best route to a destination to be taken by a particular driver of a particular equipment for the particular shipment. The AI model learns shipping patterns and habits, and the AI engine identifies that different routes can be taken for a given shipment from a same origination point based on factors comprising one or more of: a type of shipment, a shipment origination point, a destination, a driver/operator, a shipper, an insurance coverage, a driver status and rating relative to other available drivers, a type of container, and/or a type of operator equipment or tractor-trailer.

Additional embodiments of the disclosure are presented herein, and the above example embodiments are only a partial description of one embodiment of implementing the various features provided herein.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

The attached figures present various aspects and/or features of the described embodiments, with certain features not expressly presented within the description herein. Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, operational, or otherwise) on the described embodiments.

It is understood that the use of specific component, device and/or parameter nomenclature is for example only and not meant to imply any limitations on the described embodiments. The embodiments may thus be described with different nomenclature and/or terminology utilized to describe the components, devices, parameters, methods and/or functions herein, without limitation. References to any specific proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

The description of the illustrative embodiments can therefore be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein.

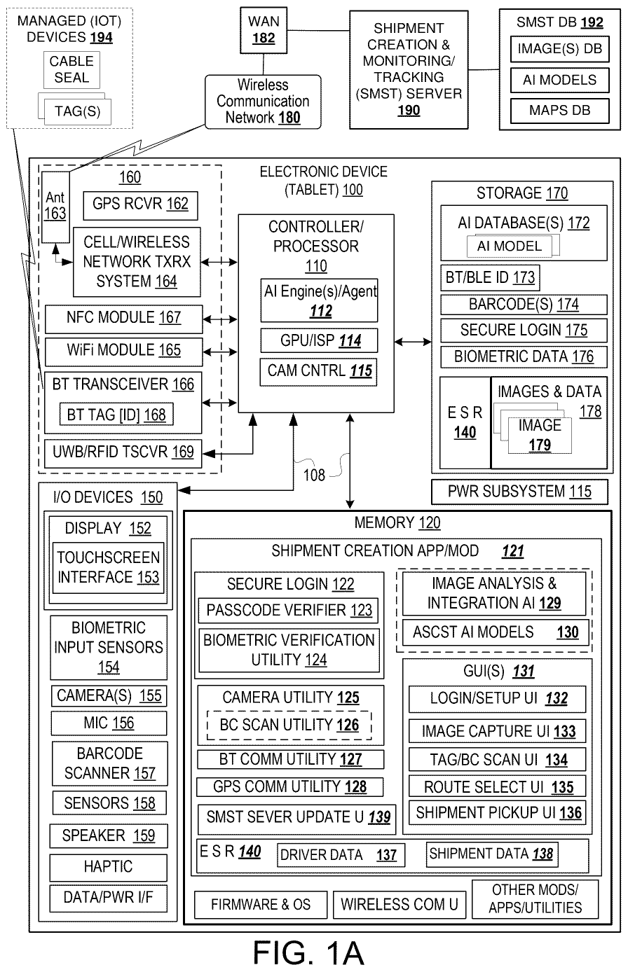

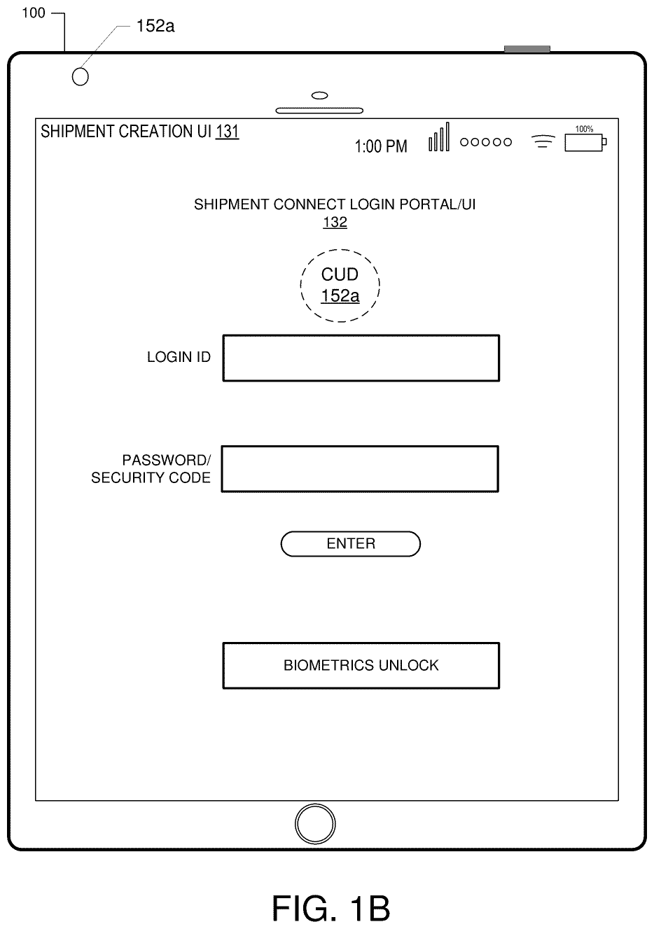

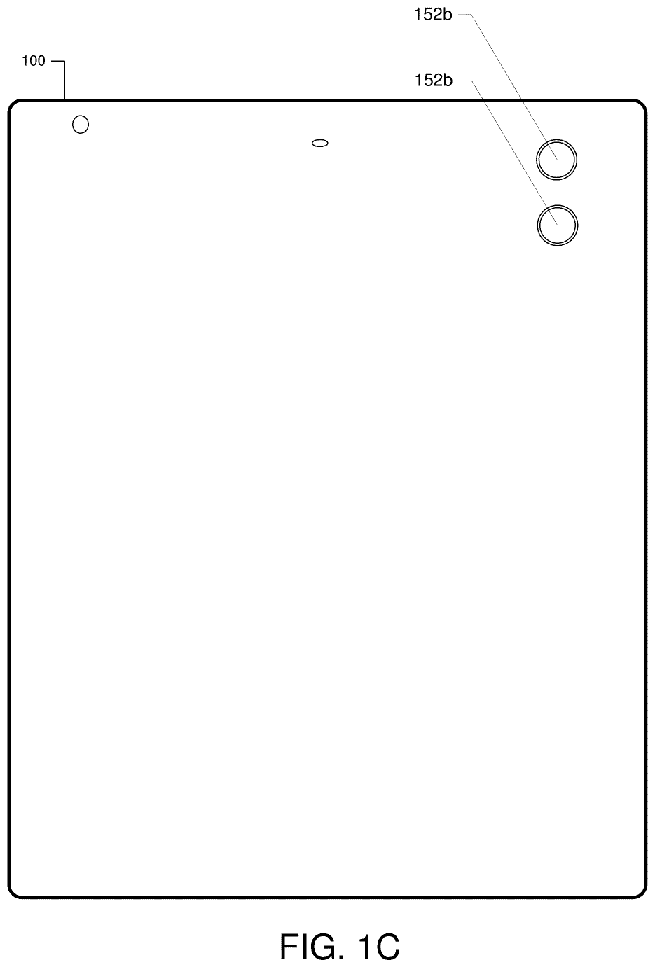

Those of ordinary skill in the art will appreciate that the hardware components and basic configuration depicted in the following figures may vary. For example, the illustrative components within electronic device 100 (FIGS. 1A-1C) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Referring now to the figures, with beginning reference to FIG. 1A. FIG. 1A illustrates an example portable electronic device, such as a table computer, configured to facilitate creation and sharing of an electronic shipment record and having additional hardware and software functionality integrated for capturing and processing photographic/digital images and/or videos of shipping entities (driver, tractor, trailer, etc.) and capturing and processing electronic data of tags, seals, and barcodes to provide enhanced security features for the shipment during shipment record generation, in accordance with multiple embodiments. Electronic device 100 includes controller 110, which incorporates functionality of a processor, and is thus interchangeably referred to as processor 110. Processor 110 includes AI engine 112, which performs the AI processing features described herein, in one embodiment. It is appreciated that the AI features can also be performed by an AI agent implemented as one function/feature of the shipment creation application described below. Processor 110 also includes graphics processing unit (GPU) and image processing unit (IPU) shown combined as (GPU/IPU 114), which are respectively used for rendering and presenting graphical user interfaces and for analyzing images and videos, as will be described in greater detail below.

References made herein to controller and/or processor are understood to refer to one or both components as providing a single management component within the electronic device 100. Controller 110 can also include one or more digital signal processors, GPUs/IPU 114, and camera controller 115. In some embodiments, the functionality of each of these additional processing components can be integrated with processor(s) 112. For example, processor 110 can, in some embodiments, include dedicated AI engine 112 and image signal processors (ISPs) 114. In some implementations, AI engine 112 can also be referred to herein as an AI agent that is a specific hardware-implemented component that provides the AI features described herein. However, the functionality attributed to an AI agent can also be completed as a special executable module that is not necessarily hardware, as described further herein. Collectively, components integrated within controller/processor 110, including processing units and AI engine 112, support computing, classifying, processing, transmitting, and receiving of data and information, and presenting of graphical and photographic images within a display.

Controller 110 manages, and in some instances directly controls, the various functions and/or operations of electronic device 100. These functions and/or operations include, but are not limited to including, application data processing, communication processing, location and navigation tasks, image processing, and signal processing. In one or more alternate embodiments, electronic device 100 may use hardware component equivalents for application data processing and signal processing.

Electronic device 100 includes memory (or memory subsystem) 120, input/output devices 150, communication subsystem 160, and data storage 170, all contained within an external device housing. Controller 110 is shown communicatively connected/coupled via system interlinks 108 with each of the various subsystems (120, 150, 160, and 170), and is directly or indirectly connected with the individual components within each subsystem. System interlink 108 represents internal wires and other components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Memory 120 may include a combination of volatile and non-volatile memory, such as random-access memory (RAM) and read-only memory (ROM). Memory 120 stores program instructions for execution by processor 110 to configure processor 110 (and more generally electronic device 100) to provide the operational functions and features described herein. Program instructions includes instructions for an operating system (OS), firmware, such as basic input/output system (BIOS) or Uniform Extensible Firmware Interface (UEFI). Program instructions also includes execution module(s) that collectively provides the various features of the disclosure. Within the illustration, memory 120 includes Shipment Creation (SC) module 121 (or automated shipment creation (ASC) module 121), which is an application that provides the features and operating functionality of the disclosed embodiments when the corresponding program instructions of ASC module 121 are processed by/within controller/processor 110. Specifically, ASC module 121 provides program instructions for automated shipment creation using a combination of execution modules or utilities that provide image analysis and processing and security data capture and application, among other features through a combination of AI agent operation, image-based information retrieval and guided user inputs and actions.

ASC module 121 includes secure login module 122 which integrates passcode/password verification utility 123 and biometric verification utility 124. SC module 121 includes camera utility 125, which optionally includes barcode scanner utility 126, enabling cameras 155 to be used for barcode scanning. ASC module 121 includes Bluetooth (BT) communication utility 127 supporting establishment and maintaining of BT connection and data exchange with a BT tag or other BT security mechanism. ASC module 121 includes GPD communication utility 128 supporting GPS location finding and location-based services by electronic device 100. ASC module 121 includes SMST server update utility 139 that supports transmission of shipping related information and updates thereto, including the created electronic shipment records (ESR) 140, to SMST server 190. ESR 140 includes driver data 137 and shipment data 138, which includes all collected data for the created shipment, including the security data and captured images.

ASC module 121 further includes AI components, such as image analysis and integration AI utility 129 and AI model(s) 130. In one or more embodiments, processor 110 can process (i.e., execute instructions of) image analysis and integration AI utility 129 and utilize AI models 130 to provide the AI functionality described herein. In other embodiments, AI models 130 are directly utilized by AI engine 112, which performs the features of image analysis and integration AI utility 129 as well as the other AI features. In the presented embodiments, AI models 130 can be integrated as a sub-module within ASC module/application 121 and is trained to support the AI features of ASC module/application 121. AI model(s) 130 may include an artificial neural network, a decision tree, a support vector machine, Hidden Markov model, linear regression, logistic regression, Bayesian networks, and so forth. AI model(s) 130 may further include a visual image identification model, a language model, a route analysis and generation model, an action model, and/or others.

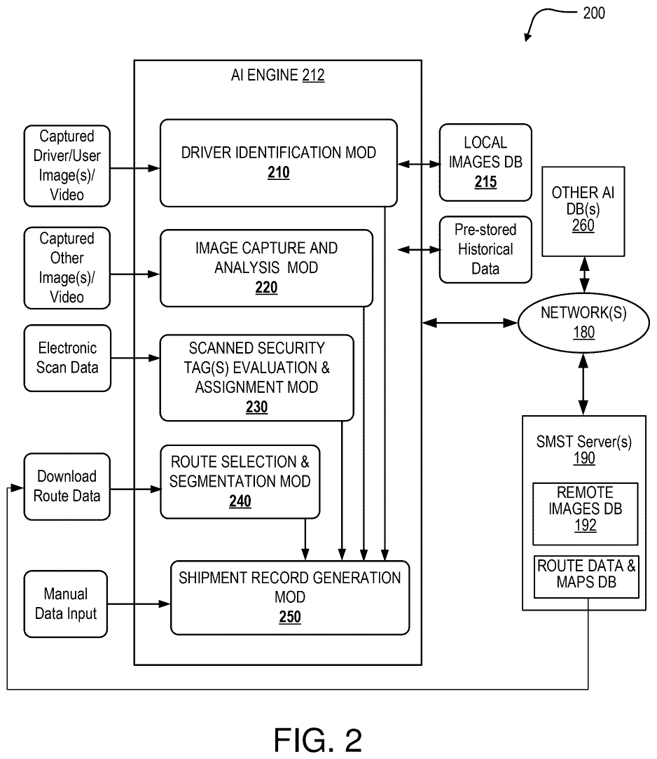

According to one or more embodiments, AI model(s) 130 can be individually trained to perform specific tasks and can be arranged in different sets of AI models to generate different types of output. Training of AI model(s) 130 is the process by which AI models are trained to perform specific tasks or achieve certain objectives. The training involves providing the model with a large amount of data and allowing the model to learn from patterns and relationships within that data. Within the disclosure, execution involving the use of AI models 130 are described as being performed by an AI agent, which can be the AI engine 112 or processor execution of specific AI modules/code (129) to provide specific AI tasks and functions. FIG. 2 presents an example operating environment 200 for the example AI agent 112, which incorporates functions provided by various ones of AI models 130. It is appreciated that other features and functions can be provided by the AI agent 112, and that the illustration of FIG. 2 is intended solely to indicate the operating environment 200 of an example AI agent 112, without limitation.

SC application 121 includes a number of GUIs 131 that are presented to user on display 152 at various stages of shipment creation. Included within GUIs 131 are, without limitation, login/setup UI 132, image capture UI 133, security tag and barcode scanning UI or security data collection UI 134, route selection UI 135, and shipment pickup UI 136. Examples of these UIs are presented in FIGS. 1B and 3-4, 7A-15. Each of the above-introduced module(s) and/or utilities and/or UIs provides program instructions that are processed by processor 110 and which configures processor 110 and/or other operational components of electronic device 100 to cause the electronic device 100 to perform specific operations and functions, as described herein. Descriptive names assigned to these modules add no functionality and are provided solely to assist in identify the underlying features performed by processing the different modules. Memory 121 can further include instructions/code for other applications, such as the OA/Firmware, wireless communication utility, and other modules/apps/utilities, providing different features of/within electronic device 100.

I/O devices 150 include an integrated display 152 which incorporates a tactile, touch screen interface 153 that can receive user's tactile/touch input. As a touch screen device, integrated display 152 allows a user to provide input to and/or to control electronic device 100 by touching features within a user interface presented on integrated display 152. Tactile, touch screen interface 153 can be utilized as an input device. The touch screen interface 153 can include one or more virtual buttons or selectable affordances. In one or more embodiments, when a user applies a finger or stylus on the touch screen interface 153 in the region demarked by the virtual button, the touch of the region causes the processor 110 to execute code to implement a function associated with the virtual button.

In addition to the touchscreen interface serving as a primary input device, I/O devices 150 includes biometric input sensor(s) 154 for biometric input during authenticated login to electronic device 100, camera(s) 155, and microphone 156. Biometric sensor 154 can be used to read/receive biometric data, such as fingerprints, to identify or authenticate a user. In some embodiments, the biometric sensor 154 can supplement an ICD (camera), which captures images for user detection/identification via facial recognition. Input devices 151 may include physical buttons/actuators (not shown) that can be located on a periphery of the device housing 105. Physical buttons may provide controls for volume, power, and camera controls 155. Microphone 156 can also be referred to as an audio input device. In some embodiments, microphone 156 may be used for identifying a user via voiceprint, voice recognition, and/or other suitable techniques, which can serve as one method of biometric authentication and/or driver identification. Input devices 151 can also include barcode scanner 157, and one or more motion or other sensor(s) 158.

I/O devices 150 includes output devices, such as, but not limited to, display(s) 152, lights (not shown), speakers (audio output devices) 159, and vibratory and/or haptic output devices. To enable physical data transfer and direct power charging of power cells of a power subsystem, electronic device 100 includes data/power interface, which may be a universal serial bus type C (USB-C) interface.

In some implementations, as illustrated by FIG. 1B, display 152 is integrated as a front surface of electronic device housing 105. A front camera may also be integrated/embedded in the front surface to enable capturing of self-images (or “selfies”), while higher quality cameras are located on a rear surface of housing 105, as shown by FIG. 1B. It is appreciated that aspects of the disclosure are applicable to other form factors and configurations of electronic devices, and presentation of device as a tablet device with a single front display is only for example, and not to be taken as limiting on the disclosure.

Storage 170 represents a repository of non-volatile data. In the presented example, storage 170 includes local AI database(s), which can include the one or more AI models. Storage 170 further includes BT/BT low energy (BLE) identifier 173 of a connected/paired BT device, such as a BLE security tag. Storage 170 can also include scanned barcodes 174, secure login credentials 175, biometric sample data 176, and captured images and data 179. Data 179 can be derived from captured images 179, in one or more embodiments.

Communications subsystem 160 includes global positioning system (GPS) receiver 162 that enables electronic device to communicate with and receive GPS location data from GPS satellite(s) (not shown). In one or more embodiments, GPS receiver 162 receives geospatial input from GPS broadcasts of time data and location data from GPS satellite(s) to obtain geospatial location information about the physical location of electronic device 100.

In one or more embodiments, controller 110, via communications subsystem 160, performs multiple types of cellular over-the-air (OTA) and/or non-cellular wireless communication, such as by using a Bluetooth connection or other personal access network (PAN) connection. As shown, communications subsystem 160 includes wireless network/cellular communication TXRX system 164, which includes at least one radio frequency RF front end coupled to one or more antennas 163. In one or more embodiments, cellular communication system 164 can include a communication module with one or more baseband processors or digital signal processors, one or more modems, and a radio frequency (RF) front end having one or more transmitters and one or more receivers. In one or more embodiments, controller 110, via communications subsystem 160, may communicate via an OTA cellular connection with radio access networks (RANs) over a cellular wireless communication network (CWCN) 180. Cellular communication systems and other types of communication systems, such as a satellite communication system, enable electronic device 100 to engage in long distance wireless communication capabilities.

In one or more embodiments, communications subsystem 160 includes one or more of near field communication (NFC) transceiver 167, Wi-Fi transceiver (TxRx) 168, Bluetooth (BT) TxRx 165, and ultra-wideband (UWB) or RFIC transceiver 169. In one or more embodiments, electronic device 100 can communicate wirelessly with external wireless devices, such as a WiFi router of a wireless local area network (WLAN) and/or second electronic devices, via one or more short-range wireless interface(s). In one or more embodiments, electronic device 100 can receive Internet or Wi-Fi based calls, text messages, multimedia messages, and other notifications via a combination of wireless and wired networks (generally communication networks). Electronic device 100 communicatively connects, via a corresponding short-range wireless interface, to one or more managed (IoT) devices 194, including BT/BLE tags and cable seal, which support some of the security features of the described embodiments.

According to one aspect of the disclosure, electronic device 100 is communicatively connected to SMTS server 190 via wireless communication network 180 and wide area network 182. SMST server 190 includes and/or is communicatively connect to SMST database DB 192, which includes server or networked versions of images DB, AI models, and Maps DB.

Referring now to FIGS. 1B and 1C. FIG. 1B illustrates an example front surface of the portable electronic device of FIG. 1 having a front display on which is presented a login screen of a shipment creation user interface (UI) for initiating creation of a shipment record based on entry of user credentials or biometric authentication, in accordance with one or more embodiments. FIG. 2B illustrates a back surface of the portable electronic device with two integrated cameras capable of being activated to capture images and video and/or to perform a scan function for scannable data to support automation of creation of the shipment record, in accordance with one or more embodiments. A selected one of integrated rear cameras 155b can be used as the active camera during the image capture operations described herein. Electronic device 100 includes front cameras 155a and rear cameras 155b (collectively referred to herein as camera 155). In one embodiment, one of front cameras 155a can be a camera under display. Each of front cameras 155a and rear cameras 155b are communicatively coupled to camera controller 115, which supports the operation of and processing of image data from front cameras 155a and rear cameras 155b. In one or more embodiments, one or more of the cameras can be utilized to enable biometric authentication using facial image or iris scan recognition. As shown by FIG. 1C, control buttons can be integrated into a top and/or side of device housing to enable manual control of one or more functions include capturing of images with the activated camera. It is appreciated that a virtual button can also be presented on display for receiving a touch input to initiate the capture of the images or video.

According to some embodiments, AI agent 112 triggers camera controller 115 to activate a selected one or more of cameras 155 in response to detecting user selection of an image capture icon presented within a shipment creation UI. AI agent 112 then monitors the received images from the field of view of the activated camera. In some alternate embodiments, where no separate camera controller is provided within the device, AI agent 112 directly triggers (e.g., via processor) a selected one or more of cameras 155 to activate in response to detecting user-initiation of the image capture function. The selected camera can be one of the rear facing cameras or the camera can be deterministically selected based on which camera(s) are pointing away from the position of the user for capturing objects other than an image of the driver. The image of the driver can be taken as a selfie by using the front camera 155a of the device. In one or more embodiments, the selection of one of the available cameras to activate can be based on the amount of ambient lighting surrounding the identified second devices within the space, where a darkly lit room may trigger a camera best suited for capturing images in a low ambient lighting environment. In some embodiments, external device cameras are controlled by electronic device 100 and can be activated to capture the image of the target. As an example, a user setting/configuration of electronic device 100 may trigger the cameras on a body-worn camera device or from a head-worn augmented reality (AR) glasses or smart glasses to perform the image capture processes for shipment entities, such as the tractor and trailer.

Referring specifically to FIG. 1B, electronic device 100 includes a front display 152 embedded in front surface 201 of housing 105. In some implementations, microphone 156, front cameras 155a and audio output device(s) 159 are at least partially integrated, embedded, or disposed into front surface 201. Display 152 presents a GUI for shipment connect login portal, which enables a user to log into the device using one alphanumeric entries of a login ID and password/passcode via entry fields 195 and 196 respectively. Login portal can also include selectable options 198 for use of biometric authentication. As one aspect of the disclosure, each login credential can be tied to a particular electronic device that is configured with a local version of shipment creation application or can be generally utilized in a network (server-level) implementation of the shipment creation process. For drivers and operators who deliver the shipment, the corresponding login credential is associated with a specific driver account having a user identification (ID) and personal contact data that includes a driver's name, address, driver's license number, driver's insurance or shipper rating, and other particular information associated with the driver.

The present disclosure provides an electronic device and a method for autonomously generating a shipment record for a new shipment utilizing image-based entry of shipment related information, including images of a driver, the shipping vessel(s) (e.g., tractor-trailer combination), and digitized scanning of security features associated with the shipment. According to one aspect, an artificial intelligence (AI) agent is deployed on a user device, such as a tablet, and provided with access to AI data models to support the processing and use of the image-based entries and scanned security data.

FIG. 2 is a block diagram representation of an example artificial intelligence (AI) operating environment 200 with AI engine 112 providing a driver image analysis model 210 and other AI models for implementing/supporting the various automated AI-supported features described herein, according to a some embodiments. As introduced with FIG. 1, controller/processor 110 can include programmed modules or a physical circuitry for implementing AI engine(s) 112, which provides certain of the AI processing of the present disclosure. AI operating environment 200 can include AI engine 112 which includes and/or processes instructions and data for driver image analysis model 210, image capture & analysis model 220 for other shipment entities (besides the driver), scanned security tag evaluation and assignment model 230, geographic route selection and segmentation model 240, and automated shipment record generation model 250. Both driver image analysis model 210 and image capture and analysis (ICA) model 220 accesses a local database of pre-stored images 215 to identify captured images by matching the capture images with known images in order to quickly identify the particular image and perform the required processing thereon. For example, a captured image containing a face of a driver can be matched with a previously stored image of an approved/authorized driver for particular shipments, such that the AI can facilitate accessing and presenting the list of shipments that are (have been) assigned to or are related to the particular driver once the image of the driver is captured and received by the electronic device. ICA model 220 can access remote database 192, which can be maintained at SMST server 190, for example, and which contains additional pre-stored images for AI engine to compare against the captured image when the local database 212 does not include a match of the captured image. AI engine 112 can communicatively link to other external data sources, accessible via network 180, as part of the operation of AI engine 112. Additional features of AI engine 112 and/or AI processing are described throughout the various embodiments presented herein. It is appreciated that the example shown by FIG. 2 is for example only, and that the actual component makeup of AI engine is limited only by its ability to perform the various features and functions described herein and equivalents thereof.

According to one or more aspects of the disclosure, the AI and AI models provide an implementation of RiskGPT Vision, which is an innovative tool that leverages generative pre-trained transformer (GPT) technology to enhance supply chain security through advanced image recognition and information extraction. The AI model is a type of large language model and a framework for generative artificial intelligence. The AI model provides an artificial neural network that can generate novel human-like content based on pre-training on large text data. The AI model reads and extracts text from documents and images, verifies carrier information from images of tractor-trailers, identifies specific objects in photos, and captures minute details such as bolt numbers on trailer doors. By automating these processes, RiskGPT Vision, implemented using AI engine and AI models, ensures the integrity and accuracy of shipments from departure to arrival.

Accordingly, one or more embodiments of the disclosure provide an electronic device 100 that includes a communication subsystem 160 configured to support communication between the electronic device 100 and at least one shipment monitoring and security tracking (SMST) 190 server/system via a communications network 180. The electronic device 100 includes: at least one input device; at least one output device, including a display 152 that presents one or more user interfaces 131 and prompts rendered by the electronic device 100; at least one camera 155 that captures images and video within a field of view (FOV) of the camera (i.e., integrated lens of the camera); and a memory 120 having an automated shipment creation (ASC) module 121 comprising a shipment generation/creation application with automated image capture and processing and automated scanning and association of security features. The electronic device 100 includes a controller (110) having at least one processor (or central processing unit) 110 communicatively coupled to the communication subsystem 160, each of the at least one input device, each of the at least one output device, and the memory 120. The at least one processor 110 executes program instructions of the ASC module 121. The processor 110 is configured to cause the electronic device 100 to, in response to receiving a first input for activation of the shipment generation application for creating or completing a first shipment record, present a login user interface (UI) 132 on the display 152 of the electronic device 100, the login UI 132 comprising one or more prompts and entry fields 195, 196 for receiving user login via input of credentials and/or biometrics. The processor 110 is further configure to cause the electronic device 100 to, in response to confirming receipt of an authenticated login: render and present on the display at least one data collection UI 131 for receiving shipment details and/or shipment security details corresponding to an upcoming shipment being established for tracking via the SMST system; and present a first data collection UI 133 among the at least one data collection UI with a listing of shipment-related entities requiring image capture and corresponding image capture affordances for initiating image-based input of one or more of the shipment details and/or shipment security details.

In one or more embodiments, the at least one processor 110 is configured to cause the electronic device 100 to: render and present, on the display, a shipment creation/security user interface (UI) that presents selectable options and prompts for capturing of electronic images of one or more shipment record/manifest data and shipment security data from a group comprising the driver, the driver's physical identification (ID) or license, the tractor, the trailer, the tractor VIN number, the cargo/shipment's exterior packaging, the cargo, a shipping label or identifier attached to the shipment packaging, a bar code, a cargo seal, a door seal, and the shipping facility/environment.

In one or more embodiments, the at least one processor 110 is configured to cause the electronic device 100 to: receive, as the pre-established user login, credentials and/or biometrics comprising at least one of: a text input of a login passcode received via an input device at a user interface presented on the display of the device; a biometric input from among: (i) voice audio input presented as a biometric security input that provides access to the electronic device and activates shipment creation functions of the electronic device for a driver identified as having the voice print of the receive voice audio input; (ii) a fingerprint input that opens the shipment generation UI on the display of the device with information associated with the driver pre-filled for that driver whose fingerprint was authenticated; other biometric input, such as an iris or facial scan. Further, in response to receiving the user login credentials and/or biometrics, the at least one processor is configured to cause the electronic device to: authenticate the user login as a valid/approved login; retrieve and present on the display a series of user interfaces for receipt of the shipment data and the security data for the shipment being created; identify an identity and a role of the user whose login credentials and/or biometrics was utilized to access the shipment creation UI; and auto-populate information related to the shipment based on the identity and role of the user whose login credentials and/or biometrics was utilized to gain access to the shipment creation UI.

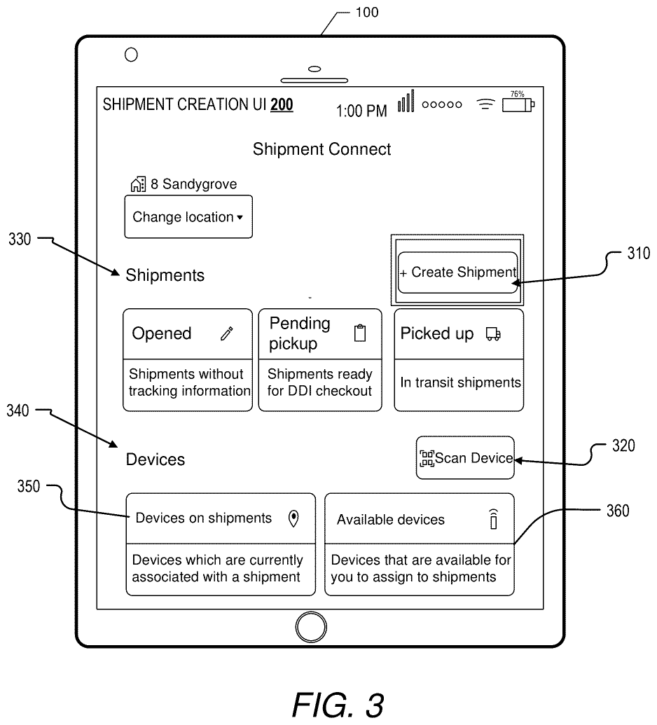

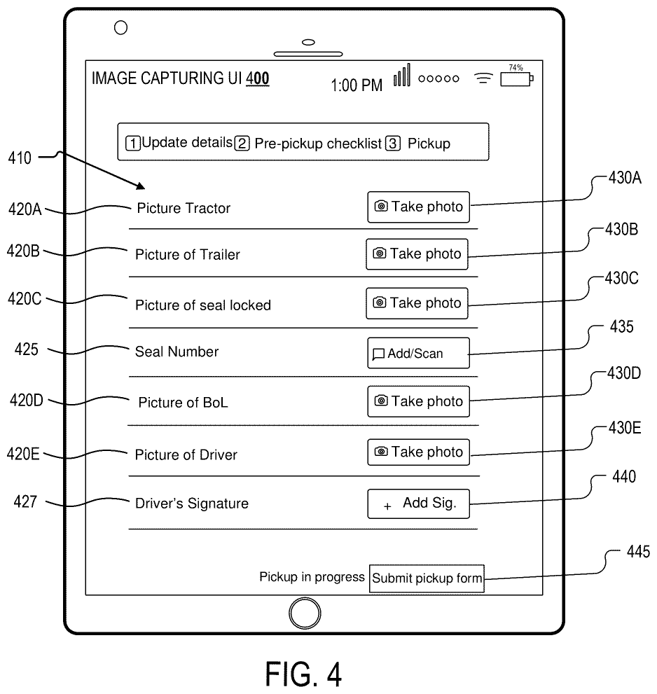

With reference to FIG. 3, in one or more embodiments, prior to presenting the data collection UI, the processor 110 is configure to cause the electronic device 100 to present shipment creation UI 300. FIG. 3 illustrates a GUI presented on device display showing an example activation page for a shipment creation application from which numerous features are initiated, including initiating the process for creating a new shipment (create shipment affordance 310) and scanning security devices (scan device affordance 320) to associate with the shipment, in accordance with one or more embodiments. Shipment creation UI 300 includes shipments overview section 330 with three categories of shipments available for selection from among opened shipments, shipments pending pickup by a driver, and shipments that have been picked up and are in progress. Shipment creation UI 300 also includes devices overview section 340 with two selectable affordances, a first for accessing devices on shipments 350 and a second for accessing a list of available devices 360, which are presented as options for user selection. On detection of selection of create shipment affordance 310, processor causes electronic device 100 to retrieve/render and present a sequence of data collection UIs 131 on display 152, including image capture UI 133 (FIG. 4). Similarly, in one or more embodiments, shipment creation process can be triggered by selection of scan device affordance 320, where the device is not previously associated with an existing shipment and no shipment is actively being created or updated.

With reference now to FIG. 4, according to one or more embodiment, the processor 110 is further configured to cause the electronic device 100 to, in response to detecting selection of the image capture affordance (take photo) 430A-430E within a first data collection UI, i.e., the image capture UI 133, among the at least one data collection UI, the first data collection UI presenting selectable options 410 pertaining to a first category 420A-420E of image capture: automatically activate a first camera 155 among the at least one camera; and present on the display 152 instructions indicating what category of information (e.g., shipment entity) 420A-420E is desired to be captured by the first camera for the first set of data. FIG. 4 depicts the display of the electronic device 100 presenting an image capturing GUI 133 of the shipment creation application 121 that enable a user of the device 100 to efficiently capture photographic images and videos of relevant shipment entities 430A-430E involved in pickup and delivery of a particular shipment being created, to facilitate generation of the electronic shipment record 145 with verifiable digitally-captured images (and resulting electronically generated data), according to several embodiments. In the illustration of FIG. 4, the driver (or shipper) is guided through a listing of the specific categories of shipping entities that are to be photographed, and the driver can select the corresponding take photo affordance 430A-430E to activate the camera and initiate taking of a corresponding photograph (or video). In one embodiment, a video option is presented once the user selects one of take photo affordances 430A-430E, so the user has the option of taking a still photograph or a video of the requested shipment entity. While presented as a sequenced list of shipping-related entities for image capture, the images do not have to be captured in any particular order, in some embodiments. Image capture GUI 133 also presents requests for entry of a seal number 425 and driver's signature 427. Seal number 425 allows for seal number 425 to be manually entered by the user or scanned in and digitally determined and inserted, in alternate embodiments. The add signature affordance 440 triggers opening of another window for manual entry of the signature on the touch screen interface, using a stylus or finger.

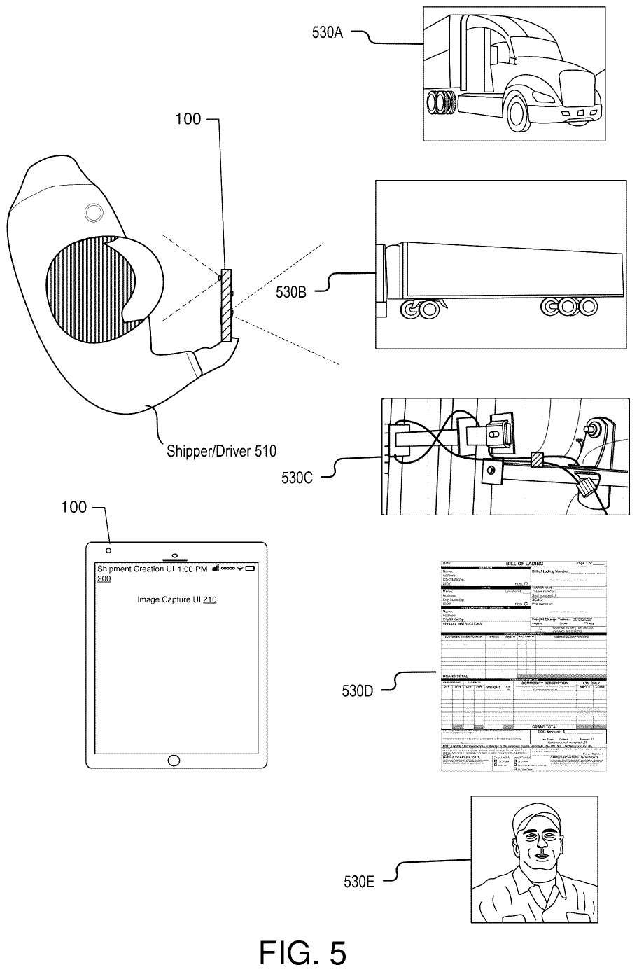

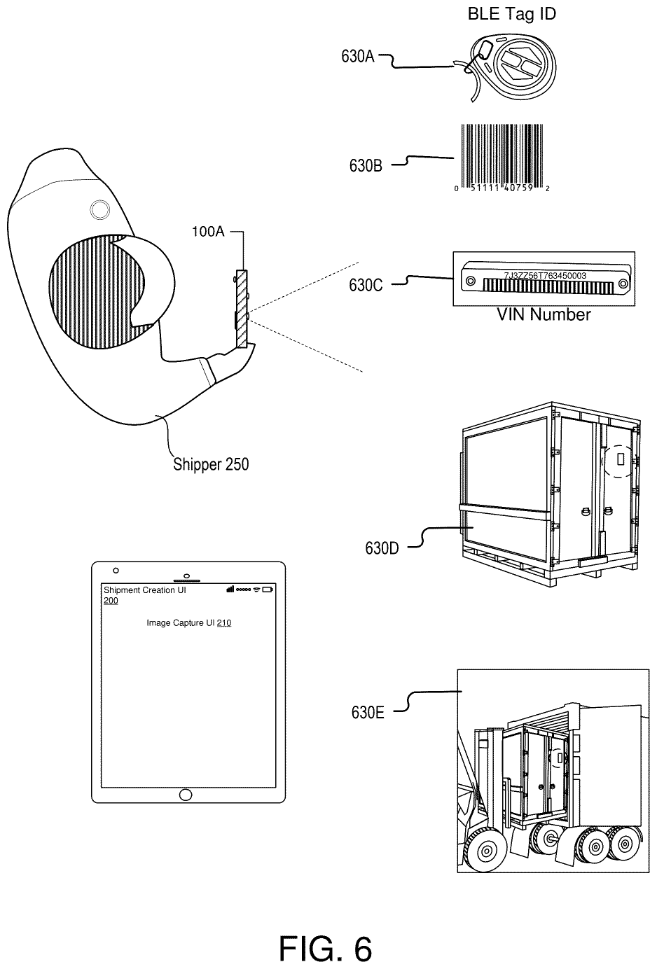

FIG. 5 illustrate the example use of the portable electronic device 100 by a device user (driver/operator/shipper) 510 to capture the requested images of the different shipment-related entities (530A-530E) associated with the shipment, including the tractor 530A, trailer 530B, and security components, including the security seal 530C, a printed bill of laden (BOL) 530D, and the driver 530E, according to multiple embodiments. FIG. 6 similarly presents additional example use of the portable electronic device 100 by the device user (driver/operator/shipper) 510 to capture images of additional shipment-related entities (630A-630E), including images of security related items, such as BLE tag 630A and uniquely generated barcode 630B for applying to the shipment record or printed BOL/AWB, and the VIN number 630C of the tractor. Also, additional images associated with the shipment can be taken, including the exterior packaging/crate 630D of the cargo and any defining characteristics thereof, such as an attached barcode or location tag, and images to evidence the on-loading of the cargo 630E into the trailer, before the cable seal 530C (FIG. 5) is affixed to the doors/door handles.

Accordingly, in one or more embodiments, the electronic device 100 includes an electronic tag reader communicatively coupled to the at least one processor. The at least one processor 110 is configured to cause the electronic device 100 to: render and present, within a shipment creation UI, a tag capturing request or prompt to trigger scanning of an electronic tag having a unique signature and attached to one or more of the shipment packaging, the trailer, the cargo, a pallet on which the cargo is placed, a container in which the cargo is placed, or other scannable location in proximity to the cargo during the shipment; and responsive to receipt of scan data from scanning the tag, embed the scan data into the first shipment record and upload the scan data to the SMST system 190 with the first shipment record.

In one or more embodiments, the electronic device 100 includes an electronic barcode reader/scanner 157 (FIG. 1) communicatively coupled to the at least one processor 110. The at least one processor 110 is configured to cause the electronic device 100 to: render and present, within a shipment creating UI, a barcode scanning request or prompt for initiation of a scan of a barcode affixed to an exterior of a shipment and/or on documents corresponding to the shipment, the barcode comprising electronic data in printed form that identifies relevant information corresponding to the shipment, the barcode usable to identify and link the shipment to the electronic shipment record being generated; add, via an AI engine, the scanned barcode to an electronically generated record for the shipment, the electronically generated record being printable with the scanned barcode affixed thereto; and add, via the AI engine, the scanned barcode to a printable label generated for attaching to an exterior packaging of the shipment.

It is appreciated that not all images are required to be captured for the shipment record to be deemed complete. However, as one security feature, the image of the driver is required in order to visually confirm that the driver who is picking up the shipment is the correct/authorized driver for that shipment. The AI engine 112 performs a real-time comparison of the captured driver image against known/verified stored images of the driver to ensure there is a match before the shipment can be released/dispatched to the driver. Accordingly, following the capture of an image, the processor 110 is configured to cause the electronic device 100 to, in response to detecting capture of an image or video with corresponding image content: store the captured image content to local storage 170; assign the captured image content to the shipment being created as a corresponding one of a shipment related image and/or a shipment security related image; and process the captured image content (e.g. image 179) to determine relevant data for inclusion in the first electronic shipment record 140.

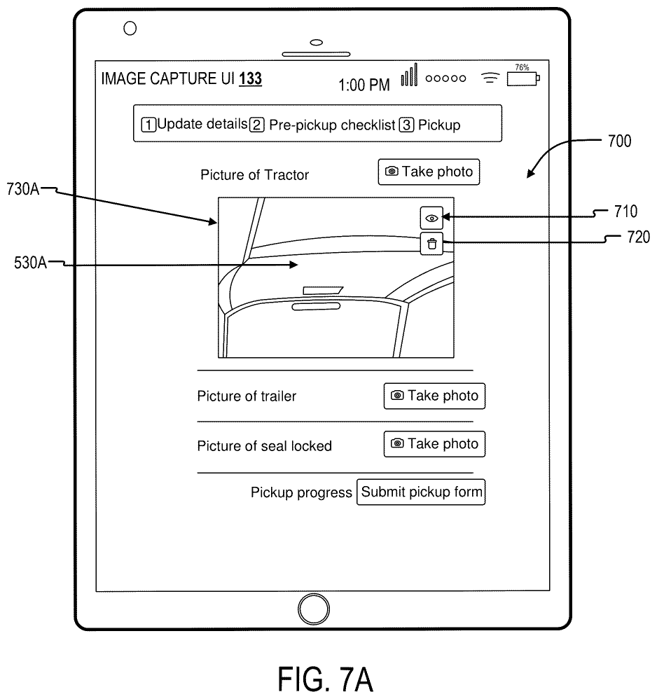

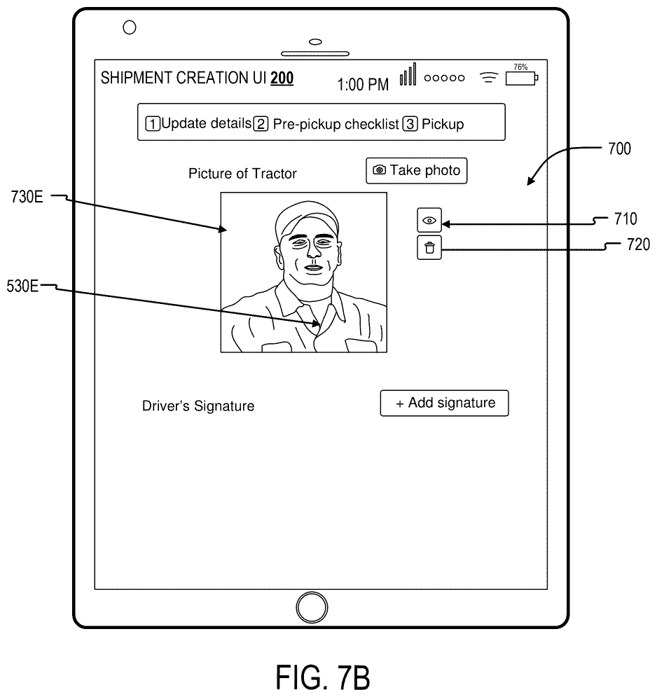

FIG. 7A illustrates the presentation on the display of the captured images within a confirmation window 700 of the image capture UI 133, presenting the captured image 730A of the tractor 530A (FIG. 5) to the user following the image capture process initiated from the selection of the image capture affordance 430A of FIG. 4. FIG. 7B illustrates the presentation on the display of the captured image 730E within confirmation window 700 of the image capture UI 133, presenting the captured image 730E of the driver 530E (FIG. 5) to the user following the image capture process initiated from the selection of the image capture affordance 430E of FIG. 4. Within each of the windows, the presented image is presented with a save/accept option 710 and a delete option 720 allowing the user to decide whether to accept or delete (and retake) the image.

In one or more embodiments, the AI agent 112 (FIGS. 1A and 2), in response to receiving an image or video contemporaneously with the electronic device 100 outputting a request or prompt for image capture of a driver/operator of a shipment transport vessel: evaluates one or more frames of the image or video for a face; in response to detecting a face, compares one or more characteristics of the detected face against a local image database comprising facial images of one or more driver/operator, each having an associated driver identifier (ID) and corresponding driver related data; and identify the driver and the associated driver ID, in response to a match of the detected face within the local image database. Additionally, the at least one processor 110 is further configured to cause the electronic device 100 to, in response to finding a match of the detected face with a first facial image stored within the local image database (178): determine from evaluating information about the specific shipment and the corresponding driver related data, whether the driver identified in the captured image is a correct driver to receive the shipment; and in response to the identified driver not being deemed the correct driver, activate a shipment hold to prevent generation of final shipping documents required to enable dispatch of the shipment.

In one or more embodiments, the at least one processor 110 is further configured to cause the electronic device 100 to: in response to the identified driver being confirmed as the correct driver, match the identified driver to the specific shipment within the first shipment record; and update the first shipment record to include shipping data and the facial image of the identified driver for use as a security confirmation image during shipment delivery verification.

In one or more embodiments, in response to identifying the driver in the local image database, the at least one processor 110 is further configured to cause the electronic device 100 to: access, via the communication subsystem, using the associated ID, a shipping database (192) of driver/operators having associated driver IDs and specific characteristics (e.g., shipping clearances and shipment authorizations of the driver, and driver ratings) and corresponding to the identified driver/operator for a plurality of authorized and/or approved drivers; and download and autonomously enter relevant driver and shipping data for the identified driver/operator to the first shipment record, in part based on the specific characteristics of the identified driver/operator.

In one or more embodiments, the AI agent, in response to not identifying a match of the detected face within the local image database: triggers the electronic device to access, via the communication subsystem, a remote image database (192) and trigger a comparison of the detected face against a plurality of driver images in the remote image database; and in response to a match to a driver image in the remote image database, retrieve, from the remote image database, a corresponding identifier (ID) of the driver and other data associated with the driver. Also, the at least one processor is further configured to cause the electronic device to, in response to finding a match of the detected face within the remote image database: determine from evaluating information about the specific shipment and the corresponding driver related data, whether the driver identified in the captured image is a correct driver to receive the shipment; and in response to the identified driver not being deemed the correct driver, activate a shipment hold to prevent generation of final shipping documents required to enable dispatch of the shipment. The at least one processor 110 is further configured to cause the electronic device 100 to, in response to the identified driver being confirmed as the correct driver: match the identified driver to the specific shipment within the first shipment record; and update the first shipment record to include shipping data and the facial image of the identified driver for use as a security confirmation image during shipment delivery verification.

In one or more embodiments, in response to the identified driver not being deemed the correct driver, the at least one processor 110 is further configured to cause the electronic device to: generate and transmit, to the SMST server 190, a notification that triggers the SMTS server 190 to generate and transmit a second notification to a second communication device of at least one interested shipment related entity registered to receive notifications about potential security issues occurring with the first shipment.

In one or more embodiments, the at least one processor is further configured to cause the electronic device to: in response to a match of the detected face, update and/or supplement an entry of the first facial image in the local image database 178 with the detected face.

Additionally, in one or more embodiments, the AI agent 112, in response to receiving an image or video of a document (e.g., 530D) contemporaneously with outputting a request for entry of shipment related data within a data entry UI comprising at least one data input field: analyzes the UI to identify a type of data required to be entered into each data field of the data entry UI; evaluates and extracts relevant content from the received document image that aligns with the type of data required for each data field of the data entry UI; and autonomously adds the relevant content extracted from the received image or video of the document to granularly complete entry of the relevant content within a corresponding data field.

According to one or more aspects, and as introduced by FIG. 1A, the ASC module/application 121 includes AI models, and at least one processor is configured to cause the electronic device 100 to activate an artificial intelligence (AI) agent/engine 112 on the electronic device 100, where the AI agent 112 processes data received during intake of the shipment details and the shipment security details to autonomously generate a shipment record with integrated security features comprising images of one or more of a driver, a tactor, a trailer, a cargo, a door seal, a security tag, and a barcode.

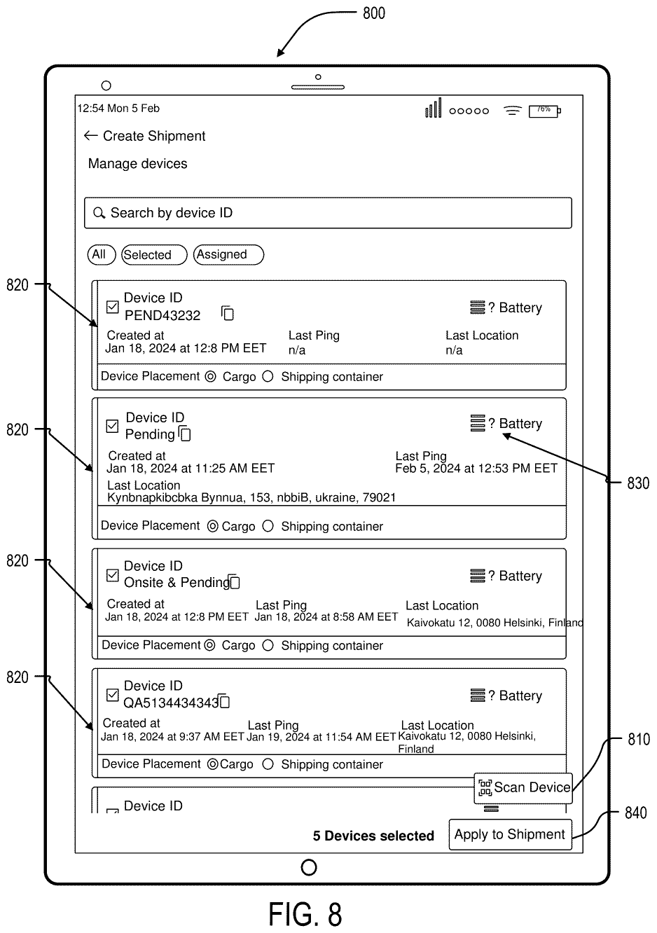

With reference now to FIG. 8, as one additional aspect of the disclosure, the at least one processor 110 is configured to cause the electronic device 100 to, present within the at least one data collection UI, e.g., the security devices UI 134, a selectable scan device affordance/option 810 for initiating scanning of one or more security details from one or more security devices or other shipment-related or security-related data provided on a physical surface. FIG. 8 presents another UI that provides a listing of the available security tags that have been scanned and associated with shipments for a same shipment entity or driver, according to some embodiments. Accordingly, the processor 110 is further configured to cause the electronic device 100 to, in response to detecting selection of the selectable scan device affordance/option 810 within a corresponding security data collection UI 134 among the at least one data collection UI: automatically activate a corresponding scanner among one or more available scanners (e.g., BT detection device, camera scanner, etc.); and present on the display, instructions indicating what information is desired to be scanned by the activated scanner. The processor 110 is further configured to cause the electronic device 100 to, in response to detecting capture of scanned digitized data or a connection signal (e.g., BT signal) during an activated scan operation of the electronic device 100: store the captured scanned digitized data to local storage 170; assign the scanned digitized data to the shipment record as a corresponding one of associated security related data for tracking security of the shipment; and process the received digitized data or connection signal to identify an associated device. In one embodiment, once a device has been scanned and processed by the AI agent, the device is added to the list of scanned and identified devices 820 along with the determined identifying and other characteristics of the device. the user is provided with an option to select the location of where the device has been placed (e.g., in/on cargo or in shipping container) and the AI generates the AI entry within the list of scanned and identified devices 820 and activates remote tracking of the security device. The AI agent presents, within the device entry, device status information including a last confirmed geographic location of the device and time of a last received device ping/update and a status of the device battery 830. The device user is able to select one or more of the added devices from within the list of devices and apply the selected ones of the devices to the shipment being created by user selection of the apply to shipment affordance 840.

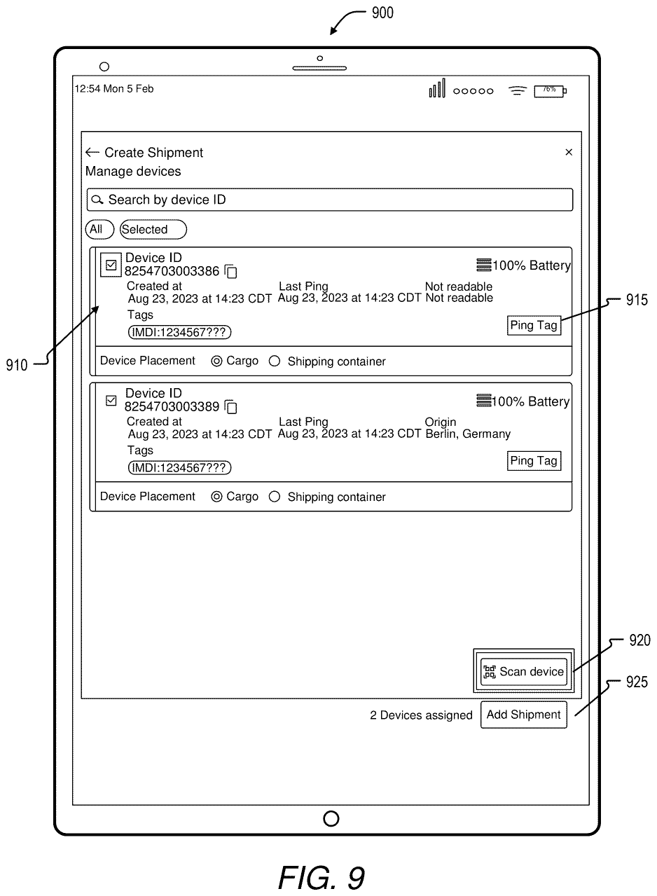

FIG. 9 presents another UI that provides a listing of intelligent door seals that have been deployed and are being tracked by the user device, according to some embodiments. As further shown by FIG. 9, when the security device supports short range communication, a second UI 900 can be presented to present a list of identifying details 910 of each found security devices and present a selectable affordance 915 to ping and/or establish communication with the particular security device. The ping feature enables the user to confirm the tag is indeed online and functioning as intended. Additional affordances can be presented, including scan device affordance 920 to initiate a scan for additional security devices or add to shipment affordance 925 to add a selected security device to the shipment.

In one or more embodiments, the processor is further configured to cause the electronic device to: communicatively connect with the associated security device when the security device is configured to support wireless connectivity; download device characteristics (type of device, associated settings, connectivity data, etc.) for the connected security device; and modify an UI of the application to present a listing of the connected security devices along with an identifier and status information corresponding to the connected security device. The processor is further configured to cause the electronic device to integrate relevant data of the connected device into the first shipment record; and generate the first shipment record to include a combination of user entered data, the captured image content, relevant data determined from the captured image content, and status and tracking information for the scanned security devices. The processor is further configured to cause the electronic device to transmit the first shipment record comprising the captured image content and the scanned content, along with other received shipment data and security data, to the SMTS server to trigger SMTS server to activate image-based security monitoring and tracking of the created shipment and/or the confirmation of the driver picking up the shipment.

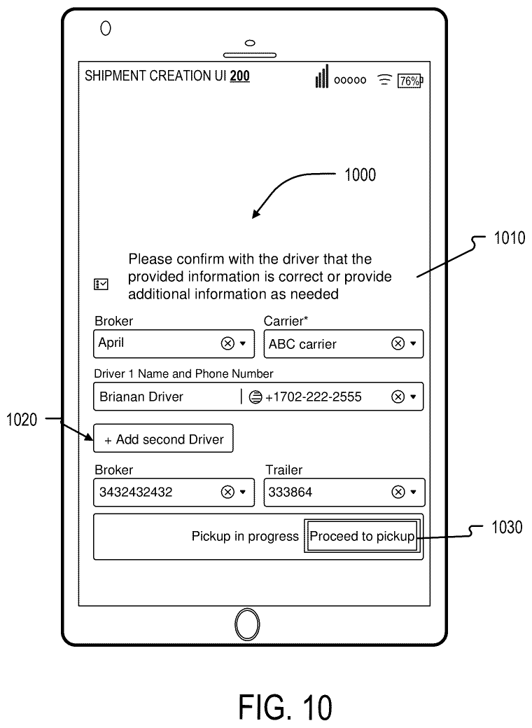

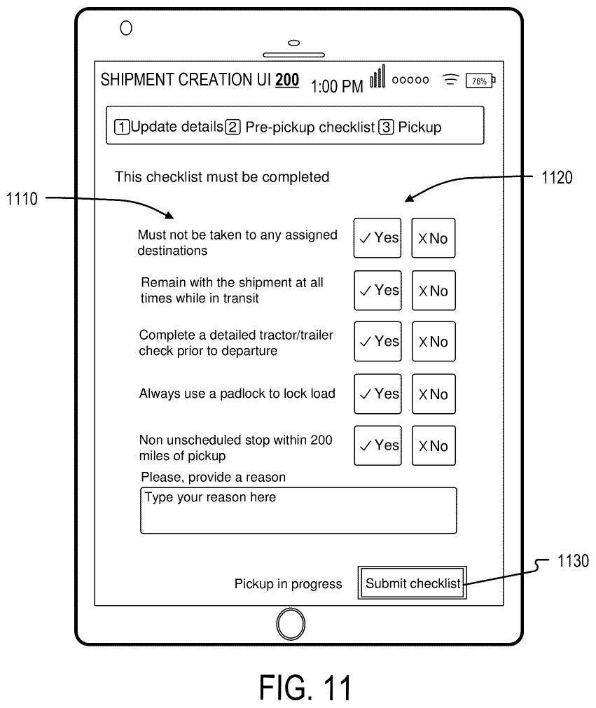

FIG. 10 provides an additional GUI presented for confirmation of driver provided or AI-deduced information for mapping to the shipment record, according to some embodiments. Confirmation GUI 1000 presents a notification 1010 to trigger the driver or shipper to confirm the driver and carrier information and, if needed, to add a second driver, via corresponding add second driver affordance 1020. Once the driver is confirmed, user may select proceed to pickup affordance 1030 to enable the driver to be verified and allowed to proceed with the pickup of the shipment. FIG. 11 presents a list of driver directives or checklists 1110 that are automatically generated and provided to the driver of the shipment, after confirmation of the driver and prior to or following release of the shipment to the driver, according to some embodiments. Each directive 1110 is accompanied by a pair of user selectable options 1120 for Yes or No. Completion of the checklist can be provided by selection of the submit checklist affordance 1130.

In one or more embodiments, the electronic device includes a location sensor coupled to the at least one processor. The at least one processor is configured to cause the electronic device to: identify, from location data received from the location sensor, a current geographic location of the electronic device; access a database of approved shipment originating addresses or shipping entity facility locations having a known shipping location from which an authenticated driver/operator/shipper/recipient can initiate document preparation for a local shipment pickup; and responsive to the current geographic location being an approved shipment originating address or shipping entity facility location, autonomously associate and enter into a shipment origination address field of the first shipment record, an address of the current geographic location as a shipment origination address, and a name and contact details of the authenticated user in a shipment creator field.

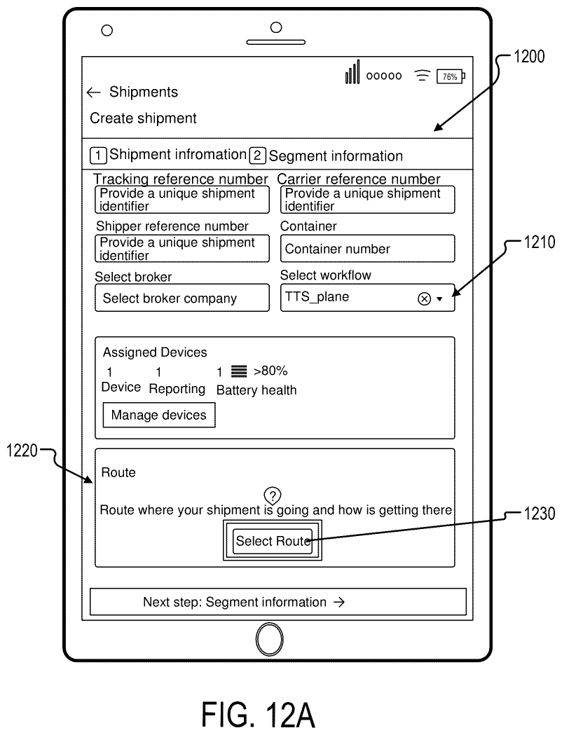

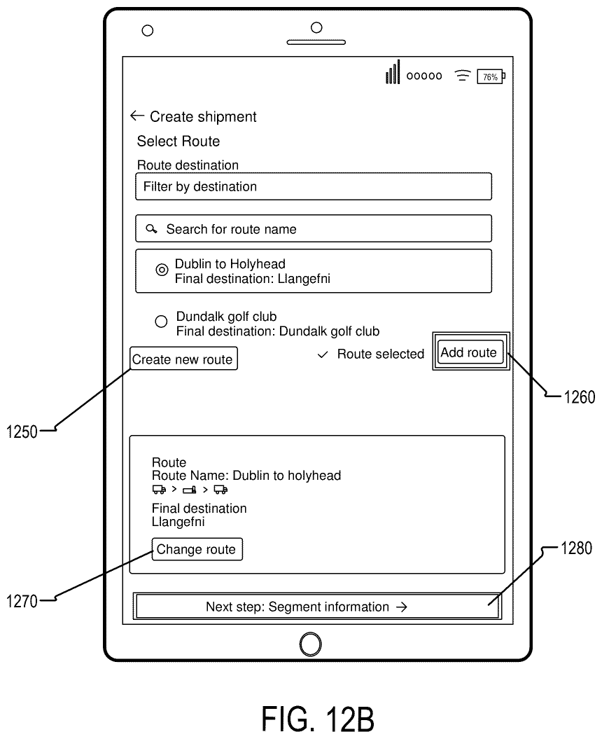

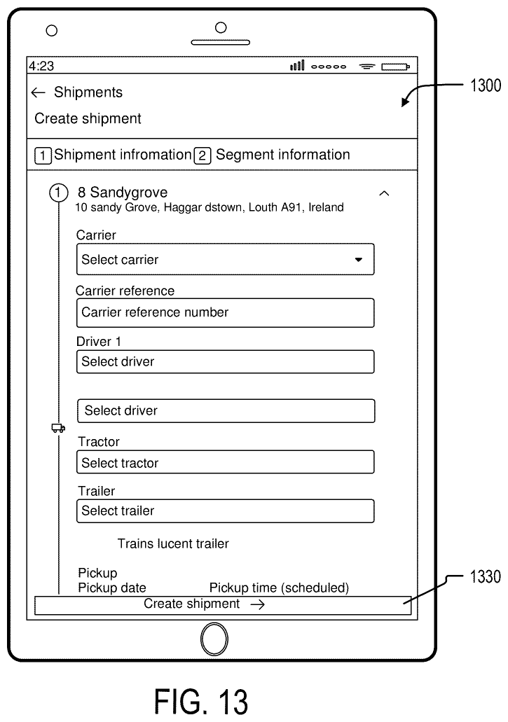

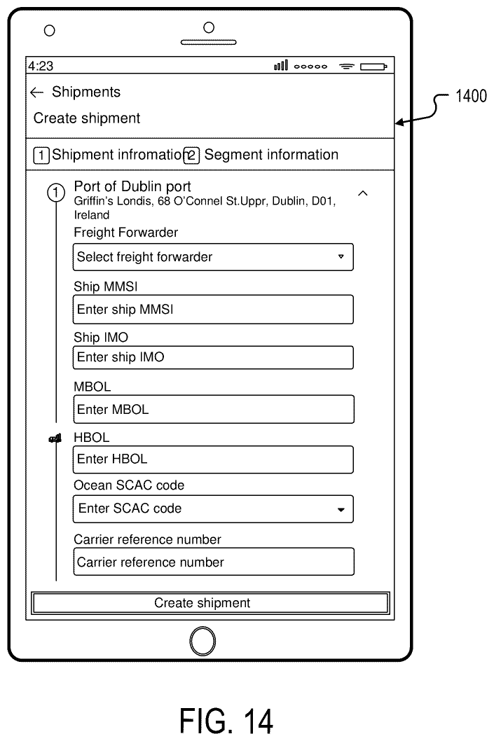

FIGS. 12A-12B and 13 provide a sequence of example route selection UIs 136, presenting options for selecting and/or changing a route and/or breaking the selected route into segments as a part of the enhanced shipment setup, according to some embodiments. The user can enter a destination and/or route using a dropdown listing of addresses, that can be determined based on historical pickup and/or drop-off location, relative to the current device location. Other data can also be added, including, for example, time and temperature sensitive (TTS) shipment designations. At FIG. 12A, information about a shipment is presented including specific workflow option 1210, such as TTS shipment, which can affect delivery timing, route, and driver selection. From this UI, the shipper or driver is presented a route selection section 1220, which includes select route affordance 1230 that allows the opening of the route selection UIs 135 and activation of route selection features of the shipment creation process. Route selection UI 135 can also present entries of assigned security/tracking devices, including a current status of that assigned devices. The select route affordance 1230 can be selected to open a route selection UI 135 (FIG. 12B) within which the route selections can be added, changed/segmented, etc. by selecting the appropriate one of the affordances. Within FIG. 12B, user is provided the option to create new route 1250 or add a route 1260 or change an existing route 1270. Route segments can also be added by selection of segment information affordance 1280, which triggers opening of segment creation UI 1300 (FIG. 13) on display for user entry of specific segment details into the corresponding entry fields. In one or more embodiments, the segments can involve a change in one or more of the carrier, the driver, and the tractor or trailer assigned to the shipment. Once the segment information is entered, the user selects create shipment affordance 1330 to initiate the final generation of the shipment record. FIG. 14 illustrates an example UI 1400 presenting entry fields for supporting ocean and/or air segments of a shipment, according to some embodiments.

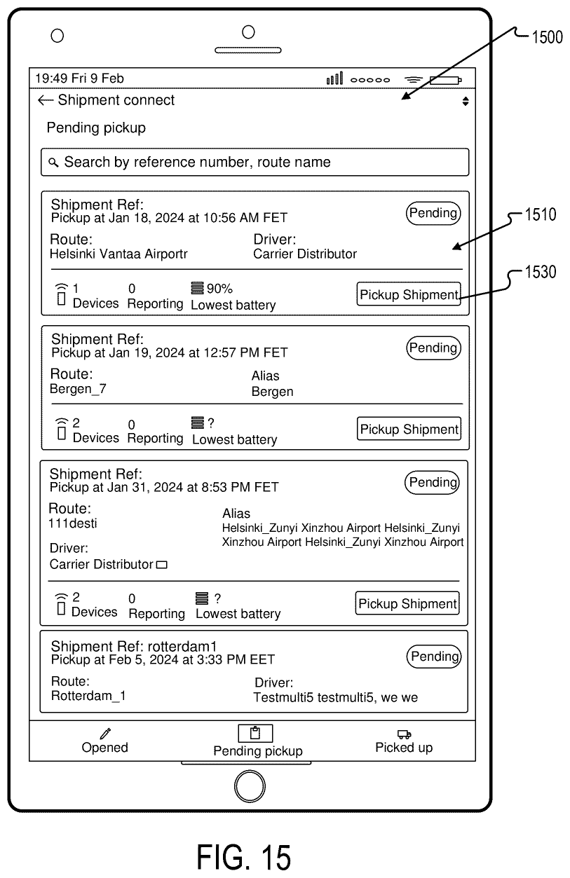

FIG. 15 presents an example pending pickup UI 1500 that electronically informs a driver of available shipments for pickup along with battery status information about the security devices assigned to the shipments the driver is responsible for, according to some embodiments. This overview enables the driver to monitor a plurality of shipments from a single main interface and decide which shipments to proceed with the pickup. A pickup shipment affordance 1530 is presented along with each shipment 1510 in the presented list of available shipments for the driver. The driver is able to select a specific shipment for pickup and the corresponding electronic shipment record (i.e., the shipment manifest and other particulars) is then presented on the display for the driver to access.

In one or more embodiments, the at least one processor is configured to cause the electronic device to: generate, as the first shipment record, a set of shipment related electronic documents that allows for security tagging and tracking of the created shipment, wherein the generation is completed by AI engine processing of the received images or video and scanned data, using one or more available AI data models. The AI engine utilizes an AI model that is pre-programmed to learn shipping patterns and habits associated with one or more of the shipper, the driver, insurance company, the shipment recipient, and/or other interested parties. Also, the AI engine further utilizes an AI model to determine additional shipping data, comprising a best route to a destination to be taken by a particular driver of a particular equipment for the particular shipment. The AI model learns shipping patterns and habits, and the AI engine identifies that different routes can be taken for a given shipment from a same origination point based on factors comprising one or more of: a type of shipment, a shipment origination point, a destination, a driver/operator, a shipper, an insurance coverage, a driver status and rating relative to other available drivers, a type of container, and/or a type of operator equipment or tractor-trailer.

In one or more embodiments, the at least one processor is configured to cause the electronic device to: store, within the first shipment record, collected shipment details including the generated shipment documents and one or more sets of captured images and/or image-retrieved information; and package and transmit the first shipment record to the (SMST) system to trigger server storage of the shipment details, wherein the shipment record is providing a record ID and made available for secure access by one or more authenticated shipment related entity during and after a life-cycle of the shipment.

In one or more embodiments, the processor is further configured to cause the electronic device to generate the first shipment record to include a combination of user entered data, the captured image content, and relevant data determined from the captured image content. The processor is further configured to cause the electronic device to transmit the first shipment record comprising the captured image content along with other received shipment data and security data to the SMTS server to trigger SMTS server to activate image-based security monitoring and tracking of the created shipment.

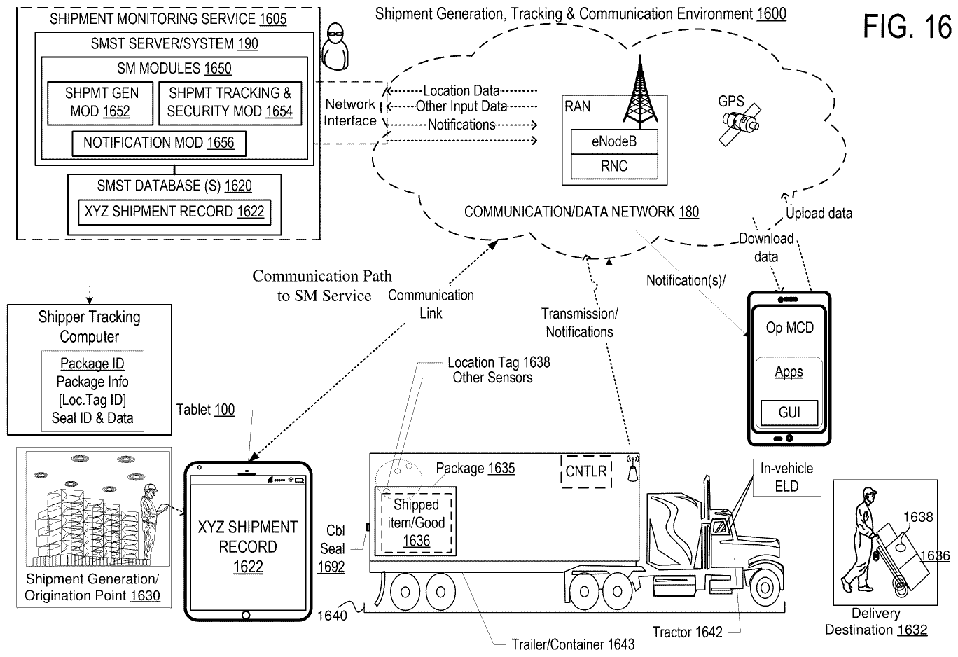

Throughout the described embodiments, references are made to the shipment monitoring and security tracking features that are being supported with the automated creation of shipment records. The present disclosure is implemented within an ecosystem of a shipment monitoring system with SMST servers providing support for the remote operations described herein. FIG. 16 illustrates an example shipment generation, tracking, and communication (SGTC) environment 1600 within which a shipment record is generated using the example portable electronic device 100 of FIGS. 1A-1C and within which delivery of a corresponding shipment 1636 is completed from a shipment generation or origination point 1630 to a destination 1632. In the presented embodiment, the delivery is completed on a shipping vessel 1640 (tractor 1642 and trailer 1643) along specific routes and with tracking and other security features enabled using one or more, or a combination, of location tags 1638 and a BLE cable seal 1692, among other tracking and security features.

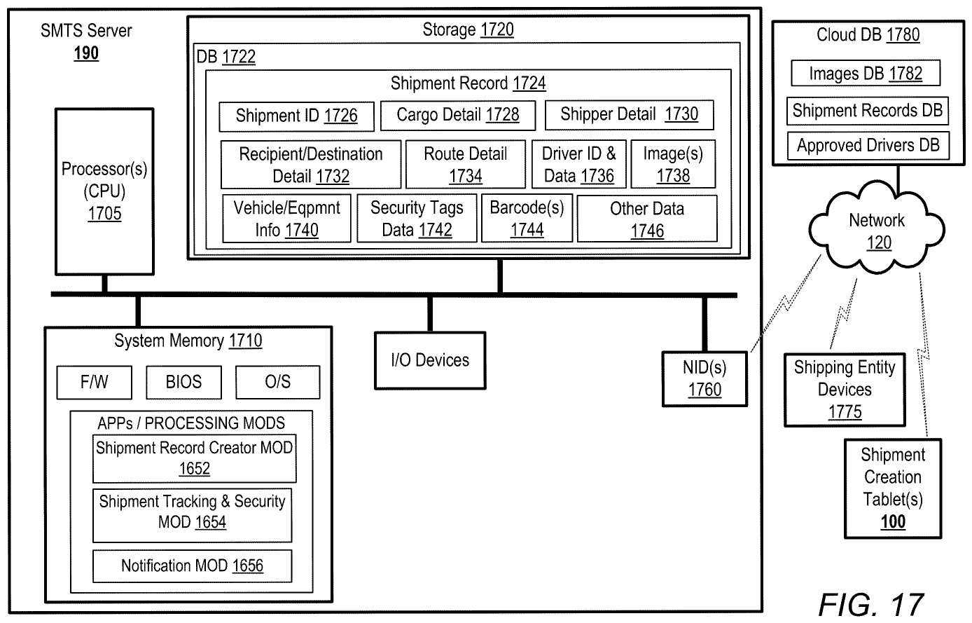

SGTC environment 1600 includes a plurality of network-connected electronic devices that exchange communication signals and data via a plurality of communication channels that are primary wireless connections. Among the network connected devices are shipper tracking computers and driver/operator mobile communication devices, both presented as separate devices from user electronic device 100 or tablet 100. These devices interface and exchange data and communication with SMST server 190 of shipment monitoring service 1605. Importantly, within SGTC environment 1600, tablet/user electronic device 100 is utilized to complete the creation of a shipment and to generate a corresponding shipment record 1622. SMST server 190 processes instructions of shipment monitoring (SM) modules 1650, which includes shipment generation module 1652, shipment tracking and security module 1654, and notification module 1656, among others. SMST server 190 includes and/or is linked to SMST database 1620, which includes a stored (persistent) copy of XYZ shipment record 1622. Additional features of SMST server 190 are provided by FIG. 17.

FIG. 17 illustrates an example data processing system (DPS) that is configured to operate as SMST server/system 190 to support shipment creation and storage of generated shipment records with digitally captured images and security data that enable subsequent monitoring and security of the generated shipment, in accordance with one or more embodiments. As shown, SMST server 190 includes processor(s) 1705 that is communicatively coupled via a system interlink to system memory 1710, storage 1720, I/O devices, and a network interface device (NID) 1760. System memory 1710 includes device firmware, operation system, and BIOS. System memory 1710 also includes applications and/or processing modules, which includes shipment record creator module 1652, shipment tracking and security module 1654, and notification modules 1656. Storage 1720 includes a local database 1722 within which shipment record(s) 1724 is stored. The illustrative embodiment provides an example of shipment record 1724, which is a shipment record that may be generated at/by the electronic device 100 interfacing with the user of the device. It is appreciated that some of the information utilized to complete shipment record 1724 can be provided by (i.e., downloaded from) data maintained at/by SMST server 190 over the network 180. Shipment record 1724 includes assigned, unique shipment ID 1726, cargo detail 1728 (type, quantity, characteristics, special handling, TTS (time and temperature sensitive) etc.), shipper detail 1730 (e.g., name, address, shipment pickup location), recipient/destination/drop-off/delivery detail 1732, route and segments detail 1734, driver identifier and other driver data/detail 1736, captured shipment entity images/video 1738, vehicle/vessel/equipment detail 1740, security tags data 1742, barcode electronic data/detail 1744, and other shipment detail 1730 (e.g., insurance, secondary drivers, notification schedules and type, relevant parties for different types of notifications), etc. It is appreciated that the above list is a non-exclusive and non-limiting list of details than can be maintained as part of the electronic record for a shipment that is created using the processes described herein.

Using NID 1760, SMST server 190 remains communicatively connected or connectable to shipment creation tablets (electronic device) 100, secondary servers (not shown), interested shipping entities/parities 1775, and cloud or other remote databases 1780. Cloud database 1780 is an example external database that include images DB 1782, which can store known images for access by AI engine during image verification or identification at electronic device 100, a shipment records DB storing copies of created (or in progress) shipment records, and an approved drivers database, which may also include ratings and other details associated with each known driver.

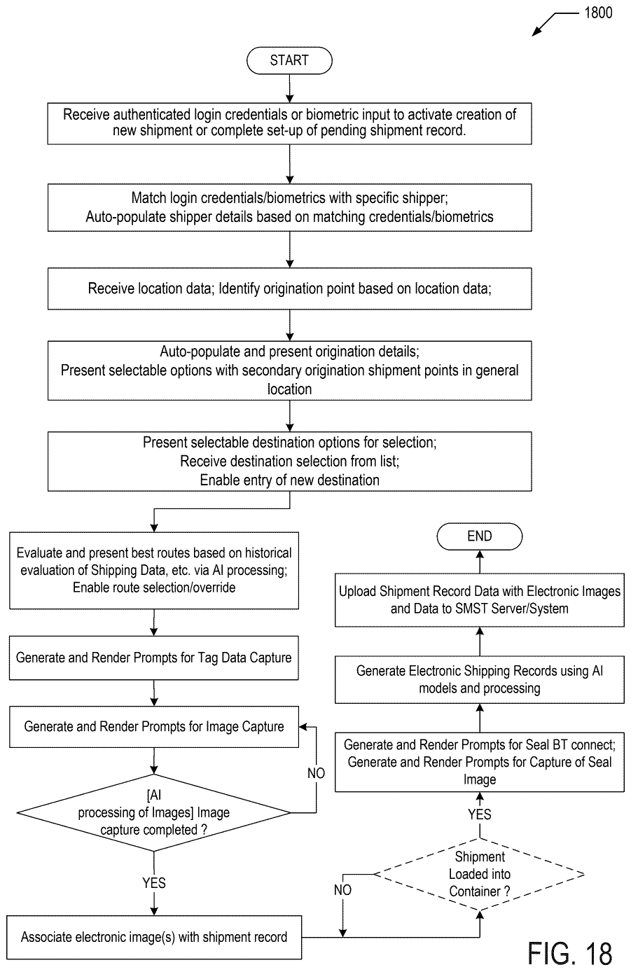

Referring now to the flowcharts presented by FIGS. 18, 19, and 20, the descriptions of methods 1800, 1900, 2000 presented by the flowcharts are provided with general reference to the specific components and features illustrated within the preceding figures. Specific components referenced in the methods 1800, 1900, 2000 may be identical or similar to components of the same name used in describing the preceding figures. In one or more embodiments, processor 110 (FIG. 1A) is configured to provide the described functionality of the methods 1800, 1900, 2000 by executing program instructions for one or more modules or applications provided within device memory 120 of electronic device 100, including ACS (or ASCST) module 125A and/or by execution of AI operative features by AI engine 112 using one or more AI models (FIG. 1A).

FIG. 18 provides a flow chart generally illustrating a method for shipment record creation that involves the capturing of electronic images and data that are embedded within (or associated with) the shipment record by AI processing to enhance the security of the shipment, in accordance with one or more embodiments. In one embodiment, the electronic device is a first hand-held (i.e., portable or mobile) electronic device. The electronic device 100 includes a memory having an automated shipment creation and security tagging (ASCST) utility with automated image-based security and tracking using artificial intelligence (AI) and AI models. The controller is configured to cause the electronic device to perform method 1800 of FIG. 18. In method 1800, the controller/processor 110 receives an initiation input for creating or completing setup of a first shipment. The initiation input can be received via a user interface presented on the display of the device. In one or more embodiment, the initiation input can include voice audio input presented as a biometric security input that provides access to the electronic device and also activates shipment creation functions of the electronic device. Other forms of biometric inputs, such as a fingerprint or an iris or facial scan, can be employed in other embodiments.

In response to receiving the initiation input, the controller causes the electronic device to retrieve and present on the display a series of user interfaces corresponding to/generate by the ASCST module. The controller causes the electronic device to identify, from sensed/received location data, a current geographic location of the electronic device, and to automatically associate a shipment origination address with a known facility or shipping location associated with the current geographic location and the ID of the authenticated user. According to one or more embodiments, the electronic device includes a GPS device that receives GPS coordinates from a GPS satellite to provide a precise geographic location of electronic device. In other embodiments, the electronic device is able to determine its rough geographic location using triangulation of cellular wireless signals received from stationary base station towers. In yet other embodiments, the electronic device is able to determine its location relative to a building using the signal strength and WiFi ID of a WiFi router from which wireless signals are detected within the area in which the electronic device is being operated.

The controller causes the electronic device to render and present, on the display, an image capturing user interface (UI) that presents selectable options and prompts for capturing of electronic images of one or more shipment-related entities from a group that includes the driver, the driver's identification or license, the tractor, the trailer, the tractor VIN number, the exterior shipment packaging, a shipping label or identifier attached to the shipment packaging, etc. In one or more embodiments, the controller causes the electronic device to render and present another UI with a prompt for initiation of a scan and or selection of an electronic tag having a unique signature and which is attached to one or more of the shipment packaging, the trailer, and a pallet on which or a container in which the shipment is placed. In one or more embodiments, the controller further causes the electronic device to render and present another UI having a prompt for scanning a barcode corresponding to the shipment.

According to one aspect, an AI engine processes the received image and scan data to generate a set of shipment related electronic documents and records that allows for the security tagging and tracking of the shipment. In one embodiment, the AI engine automatically adds the scanned barcode to a bill of laden or other record for the shipment and to a printable label generated for attaching to or on the exterior packaging of the shipment. The barcode includes electronic data that identifies relevant information associated with the shipment and can be thus used to identify and link the shipment to the electronic shipment record being generated.

According to one or more embodiments, generation of the shipment record can include automated functions provided using an artificial intelligence (AI) model pre-programmed to learn shipping patterns and habits associated with one or more of the shipper, the driver (or operator), insurance company, the recipients and/or other interested parties. Additional shipping data, such as the route taken to a destination, can be in part determined by these learned shipping patterns and habits. Different routes can thus be taken for a given shipment from a same origination point based on the shipment having a different shipper, driver, insurance coverage, or being transported via a different driver, container, tractor-trailer, etc.

Once the different sets of secondary image-based information are electronically captured, the associated data are stored within the shipment record, which is transmitted to the shipment tracking server for access by any one of the shipping related entity during the life-cycle of the shipment. Other features and functions of the described processes are provided within the presented figures, which illustrates functional features by which the controller and/or AI model of electronic device perform the creation and security association features of the shipment record, utilizing a series of UIs that enable collection of data and selection of specific features corresponding to the shipment and association of electronic image data thereto.

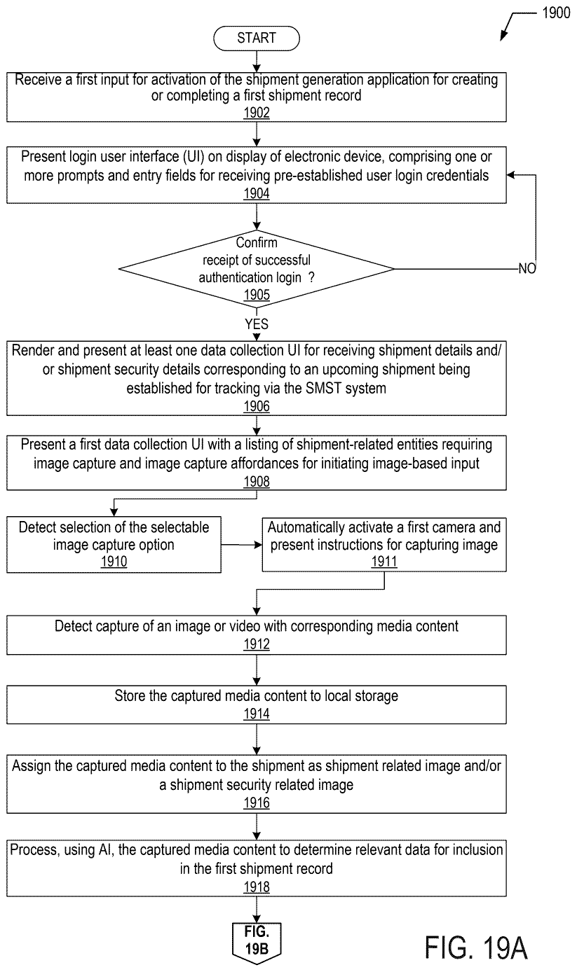

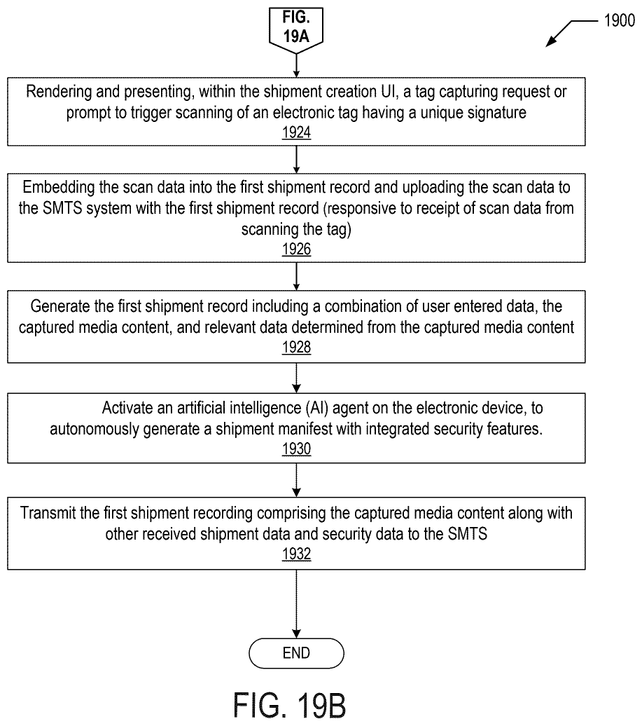

FIG. 19A-19B (collectively FIG. 19) similarly provides a flow chart generally illustrating a method for image-based creation and security of shipments. Method 1900 is a similar method as method 1800, with some differences in processing. Method 1900 provides shipment record creation that involves the capturing of electronic images and scanned security-related data that are embedded within (or associated with) the shipment record by AI processing to enhance the security of the shipment, in accordance with one or more embodiments. From the start block, method 1900 proceeds to block 1902. Method 1900 includes receiving a first input for activation of the shipment generation application for creating or completing a first shipment record (block 1902). Method 1900 includes, in response to receiving the first input for activation of the shipment generation application for creating or completing a first shipment record, presenting a login user interface (UI) on a display of an electronic device, the login UI having one or more prompts and entry fields for receiving pre-established user login credentials (block 1904). Method 1900 includes determining at decision block 1905 whether the authentication login was successful. If the authentication is not successful, method 1900 returns to block 1904 and the login UI continues to be presented pending a successful entry of login credentials.

In one or more embodiments, method 1900 includes receiving, as the user login credentials at least one of: a text input of a login passcode received via an input device at a user interface presented on the display of the device; a biometric input from among: (i) voice audio input presented as a biometric security input that provides access to the electronic device and activates shipment creation functions of the electronic device for a driver identified as having the voice print of the receive voice audio input; (ii) a fingerprint input that opens the shipment generation UI on the display of the device with information associated with the driver pre-filled for that driver whose fingerprint was authenticated; other biometric input, such as an iris or facial scan. Then, in response to receiving the user login credentials and/or biometrics, method 1900 includes: authenticating the user login as a valid/approved login; retrieving and presenting on the display a series of user interfaces for receipt of the shipment data and the security data for the shipment being created; identifying an identity and a role of the user whose login credentials and/or biometrics was utilized to access the shipment creation UI; and auto-populating information related to the shipment based on the identity and role of the user whose login credentials and/or biometrics was utilized to gain access to the shipment creation UI.

Returning to decision block 1905, in response to confirming receipt of an authenticated login credential, method 1900 includes rendering and presenting on the display at least one data collection UI for receiving one or more of shipment details and/or shipment security details corresponding to an upcoming shipment being established for tracking via the SMST system (block 1906). Method 1900 includes presenting a first data collection UI 133 among the at least one data collection UI with a listing of shipment-related entities requiring image capture and corresponding image capture affordances for initiating image-based input of one or more of the shipment details and/or shipment security details (block 1908). Method 1900 includes detecting selection of the selectable image capture affordance within a first data collection UI (block 1910). In one or more embodiments, method 1900 includes in response to selection of the selectable image capture affordance within a first data collection UI: automatically activating a first camera among the at least one camera and presenting on the display instructions indicating what information is desired to be captured by the first camera for the first set of data (block 1911).

Method 1900 includes detecting capture of an image or video with corresponding image content (block 1912). Method 1900 includes, in response to detecting capture of an image or video with corresponding image content storing the captured image content to local storage (block 1914). Method 1900 includes assigning the captured image content to the shipment as a corresponding one of a shipment related image and/or a shipment security related image (block 1916). Method 1900 includes processing the captured image content to determine relevant data for inclusion in the first shipment record (block 1918). From block 1918, method transitions to block 1920 of FIG. 19B.

FIG. 19B begins at block 1918 at which method 1900 includes rendering and presenting, within the shipment creation UI, a tag capturing request or prompt to trigger scanning of an electronic tag having a unique signature (block 1924). The electronic tag can be attached to one or more of the shipment packaging, the trailer, the cargo, a pallet on which the cargo is placed, a container in which the cargo is placed, or other scannable location in proximity to the cargo during the shipment. Method 1900 includes, responsive to receipt of scan data from scanning the tag, embedding the scan data into the first shipment record and uploading the scan data to the SMTS system with the first shipment record (block 1926).

In one or more embodiments, method 1900 can further include rendering and presenting, within a shipment creating UI, a barcode scanning request or prompt for initiation of a scan of a barcode affixed to an exterior of a shipment and/or on documents corresponding to the shipment, the barcode comprising electronic data in printed form that identifies relevant information corresponding to the shipment, the barcode usable to identify and link the shipment to the electronic shipment record being generated. Method 1900 further includes adding, via an AI engine, the scanned barcode to an electronically generated record for the shipment, the electronically generated record being printable with the scanned barcode affixed thereto. Method 1900 also includes adding, via the AI engine, the scanned barcode to a printable label generated for attaching to an exterior packaging of the shipment.

Returning to the flow chart, method 1900 includes generating the first shipment record to include a combination of user entered data, the captured image content, and relevant data determined from the captured image content (block 1928). Accordingly, method 1900 includes storing, within the first shipment record, collected shipment details including the generated shipment documents and one or more sets of captured images and/or image-retrieved information. As one process involved in generating the shipment record, method 1900 includes activating an artificial intelligence (AI) agent on the electronic device, wherein the AI agent processes data received during intake of the shipment details and the shipment security details to autonomously generate a shipment record with integrated security features comprising images of one or more of a driver, a tactor, a trailer, a cargo, a door seal, a security tag, and a barcode (block 1930). Method 1900 includes transmitting the first shipment record comprising the captured image content along with other received shipment data and security data to the SMTS server to trigger SMTS server to activate image-based security monitoring and tracking of the created shipment (block 1932). Specifically, in one embodiment method 1900 includes packaging and transmitting the first shipment record to the (SMST) system to trigger server storage of the shipment details, wherein the shipment record is providing a record ID and made available for secure access by one or more authenticated shipment related entity during and after a life-cycle of the shipment. Then, method 1900 ends at end block.

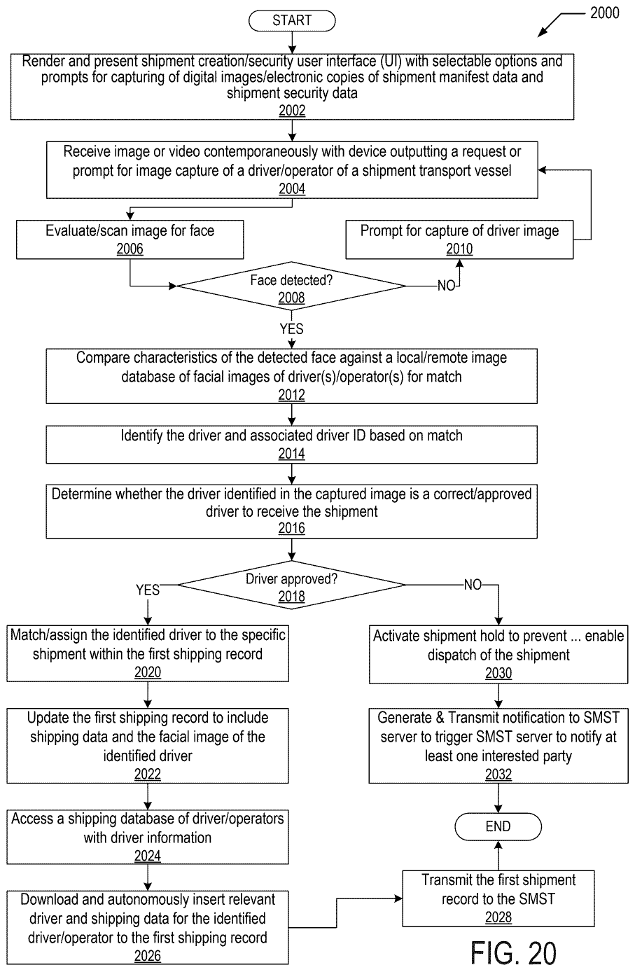

FIG. 20 provides a flow chart generally illustrating a method by which the capturing and processing of images of a driver are performed to support the automated image-assisted shipment creation with enhanced security of the shipment, in accordance with one or more embodiments. From the start block, method 2000 proceeds to block 2002. Method 2000 includes rendering and presenting, on the display, a shipment creation/security user interface (UI) that presents selectable options and prompts for capturing of electronic images of one or more shipment record data and shipment security data (block 2002). The data is captured from a group of shipment-related (or associated) entities that include the driver, the driver's physical identification (ID) or license, the tractor, the trailer, the tractor VIN number, the cargo/shipment's exterior packaging, the cargo, a shipping label or identifier attached to the shipment packaging, a bar code, a cargo seal, a door seal, and the shipping facility/environment. Method 2000 includes receiving an image or video contemporaneously with the electronic device outputting a request or prompt for image capture of a driver/operator of a shipment transport vessel (block 2004). Method 2000 includes, in response to receiving an image or video contemporaneously with the electronic device outputting a request or prompt for image capture of a driver/operator of a shipment transport vessel, evaluating one or more frames of the image or video for a face (block 2006). Method 2000 includes determining at decision block 2008 whether a face is detected. In response to not detecting a face within the image, method 2000 includes prompting for capture of a facial image of the driver (block 2010), and method 2000 returns to block 2004.

In response to detecting a face, method 2000 includes comparing one or more characteristics of the detected face against a local (or remote) image database comprising facial images of one or more driver/operator, each having an associated driver identifier (ID) and corresponding driver related data (block 2012). Method 2000 includes identifying the driver and the associated driver ID, in response to a match of the detected face within the local image database (block 2014). Method 2000 further includes, in response to finding a match of the detected face with a first facial image stored within the local/remote image database, determining from evaluating information about the specific shipment and the corresponding driver related data, whether the driver identified in the captured image is a correct/authorized/approved driver to receive the shipment (block 2016). Method 2000 includes, in response to the identified driver not being deemed the correct/approved/authorized driver, activating a shipment hold to prevent generation of final shipping documents required to enable dispatch of the shipment (block 2030). Method 2000 further includes generating and transmitting a notification to the SMST server to trigger the SMST server to generate and transmit a second notification to notify at least one interested party (e.g., the shipper) that the driver is not an approved/correct driver for the shipment. In one or more embodiments, the second notification is transmitted to a second communication device of at least one interested shipment related entity registered to receive notifications about potential security issues occurring with the first shipment.

In response to the identified driver being confirmed as the correct/approved/authorized driver at decision block 2018, method 2000 includes matching and assigning the identified driver to the specific shipment within the first shipment record (block 2020), and method 2000 further includes updating the first shipment record to include shipping data and the facial image of the identified driver for use as a security confirmation image during shipment delivery verification (block 2022).

Further, in response to identifying the driver in the local image database, method 2000 further includes accessing, via the communication subsystem, using the associated ID, a shipping database of driver/operators having associated driver IDs and specific characteristics corresponding to the identified driver/operator for a plurality of authorized and/or approved drivers (block 2024). Method 2000 further includes download and autonomously insert/enter relevant driver and shipping data for the identified driver/operator to the first shipment record, in part based on the specific characteristics of the identified driver/operator (block 2026). Method 2000 then includes transmitting the first shipment record to the SMST server (block 2028). Then, method 2000 ends.

According to one or more embodiments, the matching of the face of the driver is first completed within a local database of facial images. Accordingly, method 2000 further includes, in response to not identifying a match of the detected face within the local image database, accessing, via the communication subsystem, a remote image database and triggering comparing of the detected face against a plurality of driver images in the remote image database. Method 2000 then includes, in response to a match to a driver image in the remote image database: retrieving, from the remote image database, a corresponding identifier (ID) of the driver and other data associated with the driver; and determining from evaluating information about the specific shipment and the corresponding driver related data, whether the driver identified in the captured image is a correct driver to receive the shipment. Method 2000 further includes, in response to the identified driver not being deemed the correct driver, activating a shipment hold to prevent generation of final shipping documents required to enable dispatch of the shipment. Method 2000 further includes, in response to the identified driver being confirmed as the correct driver: matching the identified driver to the specific shipment within the first shipment record; and updating the first shipment record to include shipping data and the facial image of the identified driver for use as a security confirmation image during shipment delivery verification.

In one more embodiment, method 2000 includes, in response to a match of the detected face, updating and/or supplementing an entry of the first facial image in the local image database with the detected face.

The AI based operations of the described method 1900 include additional aspects from those generally described above. These operations/processes are described as integrated within the method 1900 or 2000; However, it is appreciated that the AI features can be completed separate from the processor features within the same method. According, method 1900 can include, in response to receiving an image or video of a document contemporaneously with outputting a request for entry of shipment related data within a data entry UI comprising at least one data input field, analyzing the UI to identify a type of data required to be entered into each data field of the data entry UI. The method 1900 can include evaluating and extracting relevant content from the received document image that aligns with the type of data required for each data field of the data entry UI, and autonomously adding the relevant content extracted from the received image or video of the document to granularly complete entry of the relevant content within a corresponding data field.

According to one ore more embodiments, method 1900 can also include identifying, from location data received from a location sensor, a current geographic location of the electronic device, and accessing a database of approved shipment originating addresses or shipping entity facility locations having a known shipping location from which an authenticated driver/operator/shipper/recipient can initiate document preparation for a local shipment pickup. Method 1900 can further include, responsive to the current geographic location being an approved shipment originating address or shipping entity facility location, autonomously associating and entering into a shipment origination address field of the first shipment record, an address of the current geographic location as a shipment origination address, and a name and contact details of the authenticated user in a field for entering the creator of the shipment.

According to one or more embodiments, method 1900 includes: generating, as the first shipment record, a set of shipment related electronic documents that allows for security tagging and tracking of the created shipment, wherein the generation is completed by AI engine processing of the received images or video and scanned data, using one or more available AI data models. In one or more implementations, the AI engine utilizes an AI model that is pre-programmed to learn shipping patterns and habits associated with one or more of the shipper, the driver, insurance company, the shipment recipient, and/or other interested parties. Also, the AI engine further utilizes an AI model to determine additional shipping data, comprising a best route to a destination to be taken by a particular driver of a particular equipment for the particular shipment, where the AI model learns shipping patterns and habits and the AI engine identifies that different routes can be taken for a given shipment from a same origination point based on factors. These factors can include one or more of: a type of shipment, a shipment origination point, a destination, a driver/operator, a shipper, an insurance coverage, a driver status and rating relative to other available drivers, a type of container, and/or a type of operator equipment or tractor-trailer.

Accordingly, an electronic device and method provide automated creation of shipments using image-capture-based information gathering and electronic scanning for ingesting data analyzed by a processor and an AI engine to generate relevant shipment detail that provides enhanced security with the shipment lifecycle, during shipment creation, pickup from an origination point, route selection, and subsequent transportation of the shipment to its intended destination. One aspect includes presenting an image capture user interface that prompts image-based entry of one or more shipment details and security details. In response to detecting capture of an image or video of a shipping entity, the device/AI: assigns the captured image content to the shipment; process the captured image content to determine relevant data for inclusion in/with the shipment, and generate a shipment record to include a combination of user entered data, the captured image content, and relevant data determined from the captured image content. The automation of these features improves the technology space of the cargo shipment industry by providing faster and more reliable and trustworthy acquisition of data for inclusion in a shipment record, immediate assignment and tracking of security tags and door seals as well as other security features of shipments, and a reduction in mistakes in driver assignments for new shipments. Other benefits and advancements are provided to the shipping industry by the embodiments described herein.

It is appreciated that implementation of the functional features of the disclosure described herein can involve use of a combination of hardware, firmware, as well as several software-level constructs (e.g., program code and/or program instructions and/or pseudo-code) that execute to provide a series of methods that present the different features and functions of the disclosure.

In the above description, exemplary embodiments in which various aspects of the disclosure may be practiced are described or illustrated to enable those skilled in the art to practice the described concepts. It is to be understood that other embodiments may be utilized, and that logical, architectural, programmatic, mechanical, electrical and other changes may be made without departing from the spirit or scope of the present disclosure. The above description is an extended summary and therefore, should not be taken in a limiting sense, and the scope of the present disclosure will be defined by appended claims and equivalents thereof. Other aspects of the disclosure that stem from and/or are extensions of the above-described processes are presented generally within the aforementioned descriptions and/or the figures accompanying this submission. Nothing within the present descriptions is to be taken as limiting on the scope of the greater application of the disclosure within the shipment creation, security tracking, and transportation industry/space.

In the above-described methods of FIGS. 18-20, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined primarily by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program instructions for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program instructions embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals; but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link. According to one or more embodiments, a computer program product is provided that includes a non-transitory computer readable medium and program instructions on the computer readable medium that, when processed by a processor of an electronic device (e.g., electronic device 100), configures the processor to cause the electronic device to perform functions of the above-described methods.

The description of the present disclosure has been presented for purposes of illustration and example, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out the disclosure, but that the disclosure will include all embodiments falling within the scope of any appended claims. Moreover, the use of the terms first, second, etc., do not denote any order or importance, but rather the terms first, second, etc. are used to distinguish one element from another.

What is claimed is:

1. An electronic device comprising:
a communication subsystem configured to support communication between the electronic device and at least one shipment monitoring and security tracking (SMST) server/system via a communications network;
at least one input device;
at least one output device, including a display that presents one or more user interfaces and prompts rendered by the electronic device;
at least one camera that captures images and video within a field of view (FOV) of an integrated camera lens;
a memory configured to store an automated shipment creation (ASC) module comprising a shipment generation application with automated image capture and processing and automated scanning and association of security features; and
a controller comprising at least one processor communicatively coupled to the communication subsystem, each of the at least one input device, each of the at least one output device, and the memory, the at least one processor executing program instructions of the ASC module, and configured to cause the electronic device to:
in response to activation of the shipment generation application for creating or completing a first shipment record:
present a login user interface (UI) on the display of the electronic device, the login UI comprising one or more prompts and entry fields for receiving user login via input of credentials and/or biometrics;
in response to confirming receipt of an authenticated login:
render and present on the display at least one data collection UI for receiving shipment details and/or shipment security details corresponding to an upcoming shipment being established for tracking via the SMST system;
present a first data collection UI among the at least one data collection UI with a listing of shipment-related entities requiring image capture and corresponding image capture affordances for initiating image-based input of one or more of the shipment details and/or shipment security details;
in response to selection of an image capture affordance, automatically activate a first camera among the at least one camera;
in response to detecting capture of an image or video with corresponding image content:
store the captured image content to local storage;
assign the captured image content to the shipment as a corresponding one of a shipment related image and/or a shipment security related image; and
process the captured image content to determine relevant data for inclusion in the first shipment record;
generate the first shipment record to include a combination of user entered data, the captured image content, and relevant data determined from the captured image content; and
transmit the first shipment record comprising the captured image content along with other received shipment data and security data to the SMTS server to trigger SMTS server to activate image-based security monitoring and tracking of the created shipment.

2. The electronic device of claim 1, wherein the ASC module comprises artificial intelligence, and at least one processor is configured to cause the electronic device to:
activate an artificial intelligence (AI) agent on the electronic device, wherein the AI agent processes data received during intake of the shipment details and the shipment security details to autonomously generate a shipment record with integrated security features comprising images of one or more of a driver, a tactor, a trailer, a cargo, a door seal, a security tag, and a barcode.

3. The electronic device of claim 2, wherein:
the AI agent, in response to receiving an image or video contemporaneously with the electronic device outputting a request or prompt for image capture of a driver/operator of a shipment transport vessel:
evaluates one or more frames of the image or video for a face;
in response to detecting a face, compares one or more characteristics of the detected face against a local image database comprising facial images of one or more driver/operator, each having an associated driver identifier (ID) and corresponding driver related data; and
identify the driver and the associated driver ID, in response to a match of the detected face within the local image database; and
the at least one processor is further configured to cause the electronic device to, in response to finding a match of the detected face with a first facial image stored within the local image database:
determine from evaluating information about the shipment and the corresponding driver related data, whether the driver identified in the captured image is a correct driver to receive the shipment; and
in response to the identified driver not being deemed the correct driver, activate a shipment hold to prevent generation of final shipping documents required to enable dispatch of the shipment.

4. The electronic device of claim 3, wherein the at least one processor is further configured to cause the electronic device to:
in response to the identified driver being confirmed as the correct driver, match the identified driver to a specific shipment within the first shipment record; and
update the first shipment record to include shipping data and the facial image of the identified driver for use as a security confirmation image during shipment delivery verification.

5. The electronic device of claim 3, wherein, in response to identifying the driver in the local image database, the at least one processor is further configured to cause the electronic device to:
access, via the communication subsystem, using the associated ID, a shipping database of driver/operators having associated driver IDs and specific characteristics corresponding to the identified driver/operator for a plurality of authorized and/or approved drivers; and
download and autonomously enter relevant driver and shipping data for the identified driver/operator to the shipment record, in part based on the specific characteristics of the identified driver/operator.

6. The electronic device of claim 3, wherein:
the AI agent, in response to not identifying a match of the detected face within the local image database:
triggers the electronic device to access, via the communication subsystem, a remote image database and trigger comparison of the detected face against a plurality of driver images in the remote image database; and
in response to a match to a driver image in the remote image database, retrieves, from the remote image database, a corresponding identifier (ID) of the driver and other data associated with the driver; and
the at least one processor is further configured to cause the electronic device to, in response to finding a match of the detected face within the remote image database:
determine from evaluating information about the specific shipment and the corresponding driver related data, whether the driver identified in the captured image is a correct driver to receive the shipment;
in response to the identified driver not being deemed the correct driver, activate a shipment hold to prevent generation of final shipping documents required to enable dispatch of the shipment; and
in response to the identified driver being confirmed as the correct driver: match the identified driver to the specific shipment within the first shipment record; and update the first shipment record to include shipping data and the facial image of the identified driver for use as a security confirmation image during shipment delivery verification.

7. The electronic device of claim 6, wherein further, in response to the identified driver not being deemed the correct driver, the at least one processor is further configured to cause the electronic device to:
generate and transmit, to the SMTS server, a notification that triggers the SMTS server to generate and transmit a second notification to a second communication device of at least one interested shipment related entity registered to receive notifications about potential security issues occurring with the first shipment.

8. The electronic device of claim 3, the at least one processor is further configured to cause the electronic device to: in response to a match of the detected face, update and/or supplement an entry of the first facial image in the local image database with the detected face.

9. The electronic device of claim 2, wherein the AI agent, in response to receiving an image or video of a document contemporaneously with outputting a request for entry of shipment related data within a data entry UI comprising at least one data input field:
analyzes the UI to identify a type of data required to be entered into each data field of the data entry UI;
evaluates and extracts relevant content from the received document image that aligns with the type of data required for each data field of the data entry UI; and
autonomously adds the relevant content extracted from the received image or video of the document to granularly complete entry of the relevant content within a corresponding data field.

10. The electronic device of claim 1, wherein the at least one processor is configured to cause the electronic device to:
receive, as the user login, credentials and/or biometrics comprising at least one of: a text input of a login passcode received via an input device at a user interface presented on the display of the device; a biometric input from among: (i) voice audio input presented as a biometric security input that provides access to the electronic device and activates shipment creation functions of the electronic device for a driver identified as having a voice print of the receive voice audio input; (ii) a fingerprint input that opens the shipment generation UI on the display of the device with information associated with the driver pre-filled for that driver whose fingerprint was authenticated; other biometric input, such as an iris or facial scan; and
in response to receiving the user login credentials and/or biometrics:
authenticate the user login as a valid/approved login;
retrieve and present on the display a series of user interfaces for receipt of the shipment data and the security data for the shipment being created;
identify an identity and a role of the user whose login credentials and/or biometrics was utilized to access the shipment creation UI; and
auto-populate information related to the shipment based on the identity and role of the user whose login credentials and/or biometrics was utilized to gain access to the shipment creation UI.

11. The electronic device of claim 1, further comprising a location sensor coupled to the at least one processor, wherein the at least one processor is configured to cause the electronic device to:
identify, from location data received from the location sensor, a current geographic location of the electronic device;
access a database of approved shipment originating addresses or shipping entity facility locations having a known shipping location from which an authenticated driver/operator or shipper/recipient can initiate document preparation for a local shipment pickup; and
responsive to the current geographic location being an approved shipment originating address or shipping entity facility location, autonomously associate and enter into a shipment origination address field of the first shipment record, an address of the current geographic location as a shipment origination address, and a name and contact details of the authenticated user in a shipment creator field.

12. The electronic device of claim 1, wherein the at least one processor is configured to cause the electronic device to:
render and present, on the display, a shipment creation/security user interface (UI) that presents selectable options and prompts for capturing of electronic images of one or more shipment record data and shipment security data from a group comprising a driver, a driver's physical identification (ID) or license, a tractor, a trailer, a tractor VIN number, cargo/shipment's exterior packaging, a cargo, a shipping label or identifier attached to the shipment packaging, a bar code, a cargo seal, a door seal, and a shipping facility/environment.

13. The electronic device of claim 1, further comprising an electronic tag reader communicatively coupled to the at least one processor, wherein the at least one processor is configured to cause the electronic device to:
render and present, within a shipment creation UI, a tag capturing request or prompt to trigger scanning of an electronic tag having a unique signature and attached to one or more of a shipment packaging, a trailer, a cargo, a pallet on which the cargo is placed, a container in which the cargo is placed, or other scannable location in proximity to the cargo during the shipment; and
responsive to receipt of scan data from scanning the tag, embed the scan data into the first shipment record and upload the scan data to the SMTS system with the first shipment record.

14. The electronic device of claim 1, further comprising an electronic barcode reader communicatively coupled to the at least one processor, wherein the at least one processor is configured to cause the electronic device to:
render and present, within a shipment creating UI, a barcode scanning request or prompt for initiation of a scan of a barcode affixed to an exterior of a shipment and/or on documents corresponding to the shipment, the barcode comprising electronic data in printed form that identifies relevant information corresponding to the shipment, the barcode usable to identify and link the shipment to the electronic shipment record being generated;
add, via an AI engine, the scanned barcode to an electronically generated record for the shipment, the electronically generated record being printable with the scanned barcode affixed thereto; and
add, via the AI engine, the scanned barcode to a printable label generated for attaching to an exterior packaging of the shipment.

15. The electronic device of claim 1, wherein the at least one processor is configured to cause the electronic device to:
generate, as the first shipment record, a set of shipment related electronic documents that allows for security tagging and tracking of the created shipment, wherein the generation is completed by AI engine processing of the received images or video and scanned data, using one or more available AI data models;
wherein the AI engine utilizes an AI model that is pre-programmed to learn shipping patterns and habits associated with one or more of a shipper, a driver, insurance company, a shipment recipient, and/or other interested parties;
wherein the AI engine further utilizes an AI model to determine additional shipping data, comprising a best route to a destination to be taken by a particular driver of a particular equipment for the particular shipment, wherein the AI model learns shipping patterns and habits and the AI engine identifies that different routes can be taken for a given shipment from a same origination point based on factors comprising one or more of: a type of shipment, a shipment origination point, a destination, a driver/operator, a shipper, an insurance coverage, a driver status and rating relative to other available drivers, a type of container, and/or a type of operator equipment or tractor-trailer.

16. The electronic device of claim 1, wherein the at least one processor is configured to cause the electronic device to:
store, within the first shipment record, collected shipment details including generated shipment documents and one or more sets of captured images and/or image-retrieved information; and
package and transmit the first shipment record to the (SMST) system to trigger server storage of the shipment details, wherein the shipment record is providing a record ID and made available for secure access by one or more authenticated shipment related entity during and after a life-cycle of the shipment.

17. A method for image-based creation and security of shipments, the method comprising:
in response to receiving a first input for activation of a shipment generation application for creating or completing a first shipment record:
presenting a login user interface (UI) on a display of an electronic device, the login UI comprising one or more prompts and entry fields for receiving user login via input of credentials and/or biometrics;
in response to confirming receipt of an authenticated login:
rendering and presenting on the display at least one data collection UI for receiving shipment details and/or shipment security details corresponding to an upcoming shipment being established for tracking via a system monitoring and security tracking (SMST) server/system;
presenting a first data collection UI among the at least one data collection UI with a listing of shipment-related entities requiring image capture and corresponding image capture affordances for initiating image-based input of one or more of the shipment details and/or shipment security details;
in response to selection of an image capture affordance, automatically activating a first camera among the at least one camera;
in response to detecting capture of an image or video with corresponding image content:
storing the captured image content to local storage;
assigning the captured image content to the shipment as a corresponding one of a shipment related image and/or a shipment security related image; and
processing the captured image content to determine relevant data for inclusion in the first shipment record;
generating the first shipment record to include a combination of user entered data, the captured image content, and relevant data determined from the captured image content; and
transmitting the first shipment record comprising the captured image content along with other received shipment data and security data to the SMTS server to trigger SMTS server to activate image-based security monitoring and tracking of the created shipment.

18. The method of claim 17, further comprising:
activating an artificial intelligence (AI) agent on the electronic device, wherein the AI agent processes data received during intake of the shipment details and the shipment security details to autonomously generate a shipment record with integrated security features comprising images of one or more of a driver, a tactor, a trailer, a cargo, a door seal, a security tag, and a barcode.

19. The method of claim 18, further comprising:
in response to receiving an image or video contemporaneously with the electronic device outputting a request or prompt for image capture of a driver/operator of a shipment transport vessel:
evaluating one or more frames of the image or video for a face;
in response to detecting a face, comparing one or more characteristics of the detected face against a local image database comprising facial images of one or more driver/operator, each having an associated driver identifier (ID) and corresponding driver related data;
identifying the driver and the associated driver ID, in response to a match of the detected face within the local image database;
in response to finding a match of the detected face with a first facial image stored within the local image database:
determining from evaluating information about a specific shipment and the corresponding driver related data, whether the driver identified in the captured image is a correct driver to receive the shipment;
in response to the identified driver not being deemed the correct driver, activating a shipment hold to prevent generation of final shipping documents required to enable dispatch of the shipment; and
in response to the identified driver being confirmed as the correct driver: matching the identified driver to the specific shipment within the first shipment record; and updating the first shipment record to include shipping data and the facial image of the identified driver for use as a security confirmation image during shipment delivery verification.

20. The method of claim 19, wherein, in response to identifying the driver in the local image database, the method further comprises:
accessing, using the associated ID, a shipping database of driver/operators having associated driver IDs and specific characteristics corresponding to the identified driver/operator for a plurality of authorized and/or approved drivers; and
downloading and autonomously entering relevant driver and shipping data for the identified driver/operator to the first shipment record, in part based on the specific characteristics of the identified driver/operator.

21. The method of claim 18, wherein further comprising, in response to not identifying a match of a detected face within a local image database:
accessing, via a communication subsystem, a remote image database;
triggering comparing of the detected face against a plurality of driver images in the remote image database;
in response to a match to a driver image in the remote image database:
retrieving, from the remote image database, a corresponding identifier (ID) of the driver and other data associated with the driver;
determining from evaluating information about a specific shipment and corresponding driver related data, whether the driver identified in the captured image is a correct driver to receive the shipment;
in response to the identified driver not being deemed the correct driver, activating a shipment hold to prevent generation of final shipping documents required to enable dispatch of the shipment; and
in response to the identified driver being confirmed as the correct driver: matching the identified driver to the specific shipment within the first shipment record; and updating the first shipment record to include shipping data and a facial image of the identified driver for use as a security confirmation image during shipment delivery verification.

22. The method of claim 21, further comprising:
in response to the identified driver not being deemed the correct driver, generating and transmitting, to the SMTS server, a notification that triggers the SMTS server to generate and transmit a second notification to a second communication device of at least one interested shipment related entity registered to receive notifications about potential security issues occurring with the first shipment.

23. The method of claim 18, further comprising:
in response to a match of a detected face, updating and/or supplementing an entry of a first facial image in a local image database with the detected face.

24. The method of claim 17, further comprising, in response to receiving an image or video of a document contemporaneously with outputting a request for entry of shipment related data within a data entry UI comprising at least one data input field:
analyzing the UI to identify a type of data required to be entered into each data field of the data entry UI;
evaluating and extracting relevant content from the received document image that aligns with the type of data required for each data field of the data entry UI; and
autonomously adding the relevant content extracted from the received image or video of the document to granularly complete entry of the relevant content within a corresponding data field.

25. The method of claim 17, further comprising:
receiving as the user login credentials and/or biometrics comprising at least one of: a text input of a login passcode received via an input device at a user interface presented on the display of the device; a biometric input from among: (i) voice audio input presented as a biometric security input that provides access to the electronic device and activates shipment creation functions of the electronic device for a driver identified as having a voice print of the receive voice audio input; (ii) a fingerprint input that opens the shipment generation UI on the display of the device with information associated with the driver pre-filled for that driver whose fingerprint was authenticated; other biometric input, such as an iris or facial scan; and
in response to receiving the user login credentials and/or biometrics:
authenticating the user login as a valid/approved login;
retrieving and presenting on the display a series of user interfaces for receipt of the shipment data and the security data for the shipment being created;
identifying an identity and a role of the user whose login credentials and/or biometrics was utilized to access the shipment creation UI; and
auto-populating information related to the shipment based on the identity and role of the user whose login credentials and/or biometrics was utilized to gain access to the shipment creation UI.

26. The method of claim 17, further comprising:
identifying, from location data received from a location sensor, a current geographic location of the electronic device;
accessing a database of approved shipment originating addresses or shipping entity facility locations having a known shipping location from which an authenticated driver/operator or shipper/recipient can initiate document preparation for a local shipment pickup;
responsive to the current geographic location being an approved shipment originating address or shipping entity facility location, autonomously associating and entering into a shipment origination address field of the first shipment record, an address of the current geographic location as a shipment origination address, and a name and contact details of the authenticated user in a shipment creator field.

27. The method of claim 17, further comprising:
rendering and presenting, on the display, a shipment creation/security user interface (UI) that presents selectable options and prompts for capturing of electronic images of one or more shipment record data and shipment security data from a group comprising a driver, a driver's physical identification (ID) or license, a tractor, a trailer, a VIN number of the tractor, a cargo/shipment's exterior packaging, a cargo, a shipping label or identifier attached to shipment packaging, a bar code, a cargo seal, a door seal, and a shipping facility/environment.

28. The method of claim 17, further comprising:
rendering and presenting, within a shipment creation UI, a tag capturing request or prompt to trigger scanning of an electronic tag having a unique signature and attached to one or more of shipment packaging, a trailer, a cargo, a pallet on which the cargo is placed, a container in which the cargo is placed, or other scannable location in proximity to the cargo during the shipment; and
responsive to receipt of scan data from scanning the tag, embedding the scan data into the first shipment record and uploading the scan data to the SMTS system with the first shipment record.

29. The method of claim 17, further comprising:
rendering and presenting, within a shipment creating UI, a barcode scanning request or prompt for initiation of a scan of a barcode affixed to an exterior of a shipment and/or on documents corresponding to the shipment, the barcode comprising electronic data in printed form that identifies relevant information corresponding to the shipment, the barcode usable to identify and link the shipment to the electronic shipment record being generated;
adding, via an AI engine, the scanned barcode to an electronically generated record for the shipment, the electronically generated record being printable with the scanned barcode affixed thereto; and
adding, via the AI engine, the scanned barcode to a printable label generated for attaching to an exterior packaging of the shipment.

30. The method of claim 17, further comprising:
generating, as the first shipment record, a set of shipment related electronic documents that allows for security tagging and tracking of the created shipment, wherein the generation is completed by AI engine processing of the received images or video and scanned data, using one or more available AI data models;
wherein the AI engine utilizes an AI model that is pre-programmed to learn shipping patterns and habits associated with one or more of a shipper, a driver, an insurance company, a shipment recipient, and/or other interested parties; and
wherein the AI engine further utilizes an AI model to determine additional shipping data, comprising a best route to a destination to be taken by a particular driver of a particular equipment for the particular shipment, wherein the AI model learns shipping patterns and habits and the AI engine identifies that different routes can be taken for a given shipment from a same origination point based on factors comprising one or more of: a type of shipment, a shipment origination point, a destination, a driver/operator, a shipper, an insurance coverage, a driver status and rating relative to other available drivers, a type of container, and/or a type of operator equipment or tractor-trailer.

31. The method of claim 17, further comprising:
storing, within the first shipment record, collected shipment details including generated shipment documents and one or more sets of captured images and/or image-retrieved information; and
packaging and transmitting the first shipment record to the (SMST) system to trigger server storage of the shipment details, wherein the shipment record is providing a record ID and made available for secure access by one or more authenticated shipment related entity during and after a life-cycle of the shipment.
